(19) United States
(12) Patent Application Publication
(10) Pub. No.: US 2011/0107369 A1
(43) Pub. Date: May 5, 2011

(54) SYSTEM AND METHOD FOR ENABLING SOCIAL BROWSING OF NETWORKED TIME-BASED MEDIA

(76) Inventors: Christopher J. O'Brien, Brooklyn, NY (US); Andrew Wason, Atlantic highlands, NJ (US)

(21) Appl. No.: 12/294,700

(22) PCT Filed: May 2, 2007
(86) PCT No.: PCT/US07/68042

§ 371 Date: Dec. 13, 2010

Related U.S. Application Data
(63) Continuation-in-part of application No. PCT/US07/65534, filed on Mar. 29, 2007.
Application No. PCT/US07/65534 is a continuation-in-part of application No. PCT/US07/65391, filed on Mar. 28, 2007.
Application No. PCT/US07/65391 is a continuation-in-part of application No. PCT/US07/65387, filed on Mar. 28, 2007.
(60) Provisional application No. 60/787,069, filed on Mar. 28, 2006.
(60) Provisional application No. 60/787,105, filed on Mar. 28, 2006.
(60) Provisional application No. 60/787,393, filed on Mar. 29, 2006.
(60) Provisional application No. 60/746,193, filed on May 2, 2006.
(60) Provisional application No. 60/822,925, filed on Aug. 18, 2006.
(60) Provisional application No. 60/822,927, filed on Aug. 19, 2006.

(51) Int. Cl. G06F 3/01; H04N 5/445

(52) U.S. Cl. 725/38; 715/738

(57) ABSTRACT

The present invention provides an easy to use web-based system for enabling multiple-user social browsing of underlying video/DEVSA media content. A plurality of user interfaces are employed linked with one or more underlying programming modules and controlling algorithms. A data model is similarly supported and used for managing complex social commenting and details regarding a particular video set of interest. An interest intensity measurement and mapping system and mode are provided for increased use.

### CROSS REFERENCE TO RELATED APPLICATIONS

This application relates to and claims priority from the following pending applications; PCT/US07/65387 filed Mar. 28, 2007 (Ref. Motio.P001PCT) which in turn claims priority from U.S. Prov. App. No. 60/787,105 filed Mar. 28, 2006 (Ref. Motio.P001), PCT/US07/65391 filed Mar. 28, 2007 (Ref. Motio.P002PCT) which in turn claims priority from U.S. Prov. App. No. 60/787,069 filed Mar. 28, 2006 (Ref. Motio.P002); PCT/US07/65534 filed Mar. 29, 2007 (Ref. Motio.P003PCT) which in turn claims priority from U.S. Prov. App. No. 60/787,393 filed Mar. 29, 2006 (Ref. Motio.P003), U.S. Prov. App. No. 60/822,925 filed Aug. 18, 2006 (Ref. Motio.P004), U.S. Prov. App. No. 60/746,193 filed May 2, 2006 (Ref. Motio.P005), and U.S. Prov. App. No. 60/822,927 filed Aug. 19, 2006 (Ref. Motio.P006), the contents of each of which are fully incorporated herein by reference.

### FIGURE SELECTED FOR PUBLICATION

FIG. 11

### BACKGROUND OF THE INVENTION

1. Field of the Invention

The present invention relates to a system, method, and apparatus for enabling social browsing for audio and video content enabling an improved manipulation of audio and video and other time-based media. More specifically, the present invention relates a system of processes for establishing, enabling and supporting multiple social browsing, deep tagging, synchronized commenting upon and reviewing of multiple video files without changing initially secured and underlying video data wherein a series of user interfaces, an underlying program module, and a supportive data module are provided within a cohesive operating system.

2. Description of the Related Art

Consumers are shooting more and more personal video using camera phones, webcams, digital cameras, camcorders and other devices, but consumers are typically not skilled videographers nor are they able or willing to learn complex, traditional video editing and processing tools like Apple iMovie or Windows Movie Maker. Nor are most users willing to watch most video “VCR-style”, that is in a steady steam of unedited, undirected, unlabeled video.

Thus consumers are being faced with a problem that will be exacerbated as both the number of videos shot and the length of those videos grows (supported by increased processing speeds, memory and bandwidth in end-user devices such as cell phones and digital cameras) while the usability of editing tools lags behind. The result will be more and longer video files whose usability will continue to be limited by the inability to locate, access, label, discuss, and share granular sub-segments of interest within the longer videos in an overall library of videos.

In the absence of editing tools of the videos, adding titles and comments to the videos as a whole does not adequately address the difficulty. For example, there may be only three 15-second segments of interest scattered throughout a 10 minute long, unedited video.

The challenge faced by viewers is to find those few short segments of video which are of interest to them at that time without being required to scan through the many sections which are not of interest.

The reciprocal challenge is for users to help each other find those interesting segments of video. As evidenced by the broad popularity of chat rooms, blogs etc. viewers want a forum in which they can express their views about content to each other, that is, to make comments. Due to the time-based nature of the video, expressing interest levels, entering and tracking comments and/or tags or labels on subsegments in time of the video or other time-based media is a unique and previously unsolved problem. Based on the disclosure herein, those of skill in the art should recognize that such time-variant metadata has properties very different from non-time-variant metadata and will require substantially distinct means to manipulate and manage it.

Additional challenges described in Applicant's incorporated references apply equally well here including especially:

a. the fact that video and accompanying audio is a time-dependent, four dimensional object which needs to be viewed, manipulated and managed by users on a two-dimensional screen when time is precious to the user who does not wish to watch entire, unedited videos (discussed in detail below with regard to the special complexities of digitally encoded video with synchronized audio (DEVSA) data);

b. the wide diversity of capabilities of the user devices which users wish to use to watch such videos ranging from PCs to cell phones (as noted further below); and

c. the need for any proposed solution to be able to be structured for ready adaptation and re-encodation to the rapidly changing capabilities of the end-user devices and of the networks which support them.

Those with skill in the art should recognize the more generic terminology “time-based media” which encompasses not only video with synchronized audio but also audio alone plus also a range of animated graphical media forms ranging from sequences of still images to what is commonly called ‘cartoons’. All of these forms are addressed herein. The terms, video, time-based media, and digitally encoded video with synchronized audio (DEVSA) are used as terms of convenience within this application with the intention to encompass all examples of time-based media.

A further detriment to the consumer is that video processing uses a lot of computer power and special hardware often not found on personal computers. Video processing also requires careful hardware and software configuration by the consumer. Consumers need ways to edit video without having to learn new skills, buy new software or hardware, become expert systems administrators or dedicate their computers to video processing for great lengths of time.

Consumers have been limited to editing and sharing video that they could actually get onto their computers, which requires the right kind of hardware to handle their own video, and also requires physical movement of media and encoding if they wish to use video shot by another person or which is taken from stock libraries.

When coupled with the special complexities of digitally encoded video with synchronized audio the requirements for special hardware, difficult processing and storage demands combine to reverse the common notion of using “free desktop MIPS and GBs” to relieve central servers. Unfortunately, for video review and editing the desktop is just is not enough for most users. The cell phone is certainly not enough, nor is the Personal Digital Assistant (PDA). There is, therefore, a need for an improved method and system for shared viewing and editing of time-based media.

Those with skill in the conventional arts will readily understand that the terms “video” and “time-based media” as used herein are terms of convenience and should be interpreted generally below to mean DEVSA including content in which the original content is graphical.

Currently available editing tools are typically too difficult and time consuming for consumers to use, largely deriving from their reliance on the same user interface metaphors and import-edit-render pattern of high-end commercial video editing packages like Avid. One form of editing is to reduce the length and/or to rearrange segments of longer form video from camcorders by deleting unwanted segments and by cut-and-paste techniques. Another form of editing is to combine shorter clips (such as those from devices such as cell phones) into longer, coherent streams. Editors can also edit—or make “mixes”—using video and/or audio produced by others if appropriate permission is granted.

This application addresses a unique consumer and data model and other systems that involve manipulation of time-based media. As introduced above, those of skill in the art reviewing this application will understand that the detailed discussion below addresses novel methods of, and systems for, receiving, managing, storing, manipulating, and delivering digitally encoded video with synchronized audio. (Conveniently referred to as “digitally encoded video with synchronized audio (DEVSA)). Those of skill in the art will also recognize that a focus of the present application is, in parallel with the actions applied to the DEVSA, to provide novel systems, processes and methods to gather, analyze, process, store, distribute and present to users a variety of novel and useful forms of information concerning that DEVSA which information is synchronized to the internal time of DEVSA and multiply linked to the users both as individuals and as groups (defined in a variety of ways) which information enables them to utilize the DEVSA in a range of novel and useful manners, all without changing the originally encoded DEVSA.

In order to understand the concepts provided by the present, and related inventions, those of skill in the art should understand that DEVSA data is fundamentally distinct from and much more complex than data of those types more commonly known to the public and the broad data processing community and which is conventionally processed by computers such as basic text, numbers, or even photographs, and as a result requires novel techniques and solutions to achieve commercially viable goals (as will be discussed more fully below).

Techniques (editing, revising, compaction, etc.) previously applied to these other forms of data types cannot be reasonably extended due to the complexity of the DEVSA data, and if commonly known forceful extensions are orchestrated they would
Be ineffective in meeting users' objectives and/or
Be economically infeasible for non-professional users and/or
Make the so-rendered DEVSA data effectively inoperable in a commercially realistic manner.

Therefore a person skilled in the art of text or photo processing cannot easily extend the techniques that person knows to DEVSA.

What is proposed for the present invention is a new system and method for managing, storing, manipulating, editing, operating with and delivering, etc. DEVSA data and novel kinds of metadata associated with and linked to said DEVSA. As will be discussed herein the demonstrated state-of-the-art in DEVSA processing suffers from a variety of existing, fundamental challenges associated with known DEVSA data operations. The differences between DEVSA and other data types and the consequences thereof are discussed in the following paragraphs. These challenges affect not only the ability to manipulate the DEVSA itself but also manipulate associated metadata linked to the internals of the DEVSA. Hence those of skill in the art are not only faced the challenges associated with dealing with DEVSA but also face the challenges of new metadata forms such as deep tagging, synchronized commenting, visual browsing and social browsing as discussed herein and in Applicant's related applications.

This application does not address new techniques for digitally encoding video and/or audio or for decoding DEVSA. There is substantive related art in this area that can provide a basic understanding of the same and those of skill in the electronic arts know these references. Those of skill in the art will understand however that more efficient encoding/decoding to save storage space and to reduce transmission costs only serves to greatly exacerbate the problems of operating on DEVSA and having to re-save revised DEVSA data at each step of an operation if the DEVSA has been decoded to perform any of those operations.

A distinguishing point about video and, by extension stored DEVSA, is to emphasize that video or stored DEVSA represents an object with four dimensions: X, Y, A—audio, and T—time, whereas photos can be said to have only two dimensions (X, Y) and can be thought of as a single object that has two spatial dimensions but no time dimension. The difficulty in dealing with mere two dimensional photo technology is therefore so fundamentally different as to have no bearing on the present discussion (even more lacking are text art solutions).

Another distinguishing point about stored DEVSA that illustrates its unique difficulty in editing operations is that it extends through time. For example, synchronized (time-based) comments are not easily addressed or edited by subsequent users using previously known methods without potential corruption of the DEVSA files and substantial effort costly to the process on a commercial scale.

Those with skill in the art should be aware of an obvious example of the challenges presented by this time dependence in that it is common for Internet users to post comments on Web sites about specific news items, text messages, photos or other objects which appear on Web sites. The techniques for doing so are well known to those with skill in the art and are commonly used today. The techniques are straightforward in that the comment is a fixed, single data object and the object commented upon is a fixed, single data object. However the corollaries in the realm of time-based media are not well known and not supported within the current art.

As an illustrative example, consider the fact that a video may extend for five minutes and encompass 7 distinct scenes addressing 7 distinct subjects. If an individual wishes to comment upon scene 5/subject 5, that comment would make no sense if it were tied to the video as a whole. It must be tied only to scene 5 that happens to occur from 3 minutes 22 seconds until 4 minutes 2 seconds into the video.

Since the video is a time-based data object, the comment must also become a time-based data object and be linked within the time space of the specific video to the segment in question. Such time-based comments and such time-dependent linkages are not known or supported within the related arts but are supported within this model.

A stored DEVSA represents an object with four dimensions: X, Y, A, T: large numbers of pixels arranged in a fixed X-Y plane which vary smoothly with T (time) plus A (audio amplitude over time) which also varies smoothly in time in synchrony with the video. For convenience video presentation is often described as a sequence of “frames” (such as 24 frames per second). This is however a fundamentally arbitrary choice (number of “frames” and use of “frame” language) and is a settable parameter at encoding time. In reality the time variance of the pixel's change with time is limited only by the speed of the semiconductors (or other electronic elements) that sense the light.

Before going further it is also important for those of skill in the art to fully appreciate the scale of these DEVSA data elements that sets them apart from text or photo data elements, and why this scale is so extremely difficult to manage. As a first example, a 10-minute video at 24 “frames” per second would contain 14,400 frames. At 600×800 pixel resolution, 480,000 pixels, one approaches 7 billion pixel representations.

When one adds in the fact that each pixel needs 10- to 20 bits to describe it and the need to simultaneously describe the audio track, there is a clear and an impressive need for an invention that addresses both the complexity of the data and the fact that the DEVSA represents not a fixed, single object rather a continuous stream of varying objects spread over time whose characteristics can change multiple times within a single video. To date no viable solutions have been provided which are accessible to the typical consumer, other than very basic functions such as storing pre-encoded video files, manipulating those as fixed files, and executing START and STOP play commands such as those on a video tape recorder.

While one might have imagined that photos and video offer similar technical challenges, the preceding discussion makes it clear again that the difficulties in dealing with mere two dimensional photos which are fixed in time are therefore so fundamentally different and less challenging as to have no bearing on the present discussion. The preceding sentence applies at least as strongly to the issue of metadata associated with DEVSA. A tag, comment, etc. on an object fixed in time such as a text document or a picture or a photo are well-understood objects (metadata in a broad sense) with clear properties. The available technology has made such things more accessible but has not really changed their nature from that of the printed word on paper: fixed comment tied to fixed object.

In this and Applicant's related applications an emphasis is placed on metadata including tags, comments, visual browsing and social browsing information which are synchronized to the internal time-line of the DEVSA including after the DEVSA has been “edited”, all without changing the DEVSA.

By way of background information, some additional facts about DEVSA should be well understood by those of skill in the art; and these include:
a. Current decoding technology allows one to select any instant in time within a video and resolve a “snapshot” of that instant, in effect rendering a photo of that instant and to save that rendering in a separate file. As has been shown, for example in surveillance applications, this is a highly valuable adjunctive technology but it fails to address the present needs.
b. It is not possible to take a “snapshot” of audio, as a person perceives it. Those of skill in the electronic and audio-electronic arts recognize that audio data is a one dimensional data type: (amplitude versus time). It is only as amplitude changes with time that it is perceivable by a person. Electronic equipment can measure that amplitude if desired for special reasons.

The present application and those related family applications apply to this understanding of DEVSA when the actual video and audio is compressed (as an illustration only) by factors of a thousand or more but remain nonetheless very large files. Due the complex encoding and encodation techniques employed, those files cannot be disrupted or manipulated without a severe risk to the inherent stability and accuracy of the underlying video and audio content. This explains in part the importance of keeping metadata and DEVSA as separate, linked entities.

The conventional manner in which users edit digitized data, whether numbers, text, graphics, photos, or DEVSA, is to display that data in viewable form, make desired changes to that viewable data directly and then re-save the now-changed data in digitized form.

The phrase above, “make desired changes to that viewable data”, could also be stated as “make desired changes to the manner in which that data is viewed” because what a user “views” changes because the data changes, which is the normative modality. In contrast to this position, the proposed invention changes the viewing of the data without changing the data itself. The distinction is material and fundamental.

In conventional data changes, where storage cost is not an issue to the user, the user can choose to save both the original and the changed version. Some sophisticated commercial software for text and number manipulation can remember a limited number of user-changes and, if requested, display and, if further requested, may undo prior changes.

This latter approach is much less feasible for photos than for text or numbers due to the large size and the extensive encoding required of photo files. It is additionally far less feasible for DEVSA than for photos because the DEVSA files are much larger and because the DEVSA encoding is much more complex and processor intensive than that for photo encoding.

In a similar analysis, the processing and storage costs associated with saving multiple old versions of number or text documents is a small burden for a typical current user. However, processing and storing multiple old versions of photos is a substantial burden for typical consumer users today. Most often, consumer users store only single compressed versions of their photos. Ultimately, processing and storing multiple versions of DEVSA is simply not feasible for any but the most sophisticated users even assuming that they have use of suitable editing tools.

As will be discussed, this application proposes new methodologies and systems that address the tremendous conventional challenges of editing heavily encoded digitized media such as DEVSA and in parallel and in conjunction proposes new methodologies and systems to gather, analyze, store, distribute, display, etc. new forms of metadata associated with said DEVSA and synchronized with said DEVSA in order to provide new systems, processes and methods for such DEVSA and metadata to enhance the use thereof.

In a parallel problem, known to those with skill in the conventional arts associated with heavily encoded digitized media such as DEVSA, is searching for content by various criteria within large collections of such DEVSA.

Simple examples of searching digitized data include searching through all of one's accumulated emails for the text word “Anthony”. Means to accomplish such a search are conventionally known and straight-forward because text is not heavily encoded and is stored linearly. On the Internet, companies like Google and Yahoo and many others have developed and used a variety of methods to search out such text-based terms (for example “Washington's Monument”). Similarly, number-processing programs follow a related approach in finding instances of a desired number (for example the number “$1,234.56”).

However, when the conventional arts approach digitally encoded graphics or, more challengingly, digitally encoded photos, and far more challengingly, DEVSA, managing the problem becomes increasingly difficult because the object of the search becomes less and less well-defined in terms, (1) a human can explain to a computer, and (2) a computer can understand and use algorithmically. Moreover, the data is ever more deeply encoded as one goes from graphics to photos to DEVSA.

Conventional efforts to employ image recognition techniques for photos and video, and speech recognition techniques for audio and video/audio, require that the digitized data be decoded back to viewable/audible form prior to application of such techniques. As is well known to those of skill in the art, repetitive encoding/decoding with edits introduces substantial risks for graphical, photographic, audio and video data.

As an illustrative example of the substantial challenges of searching, consider the superficially simple graphics search question: “Search the file XYZ graph which includes 75 figures and find all the elements which are “ovals”.

If the search is being done with the same software which created the original file and it is a purely graphical file, the search may be possible. However, if the all the user has are images of the figures, the challenges are substantial. To name a few:
1. The user and the computer first have to agree on what “oval” means. Consider the fact that circles are “ovals” with equal major and minor axes.
2. The user and computer have to agree if embedded figures such as pictures or drawings of a dog should be included in the search since the dog's eyes may be “oval”.
3. The user and computer have to agree if “zeros” and/or “O's” are ovals or just text.

The point is that recognizing shapes gets tricky.

Turning to photos, unless there are metadata names or tags tied to the photo, which explain the content of the photo, determining the content of the photo in a manner susceptible to search is a largely unsolved problem outside of very specialized fields such as police ID photos. Distinguishing a photo of Mt. Hood from one of Mt. Washington by image recognition is extremely difficult for a computer.

Extensions of recognition technologies to video are potentially valuable but are even more difficult due to the complexities of DEVSA described previously. Thus, solutions to the problems noted are extremely difficult to comprehend, and are not available through available recourses.

This application proposes new methods, systems, and techniques to enable and enhance use, editing and searching of DEVSA files via use of novel types of metadata and novel types of user interactions with integrated systems and software. Specifically related to the distinction made above, this application addresses methods, systems and operational networks that provide the ability to change the manner in which users view and use digitized data, specifically DEVSA, without necessarily changing the underlying digitized data.

Those of skill in the art will recognize that there has been a tremendous commercial and research demand to cure the long-felt-problem of data loss where manipulating the underlying DEVSA data in situ.

Repetitive encoding and decoding cycles are very likely to introduce accumulating errors with resultant degradation to the quality of the video and audio. Therefore there is strong demand to retain copies of original files in addition to re-encoded files. Since, as stated previously, these are large files even after efficient encoding, economic pressures make it very difficult to keep many copies of the same original videos. Conversely, efficient encoding, to reduce storage space demands, requires large amounts of computing resources and takes an extended period of time to complete.

Thus, the related art in video editing and manipulation favors light repetitive encoding which in turn uses lots of storage by requires keeping more and more copies of successive versions of the encoded data to avoid degradation thus requiring even more storage. Conversely, when no editing is planned, heavy encoding is utilized to reduce storage needs. As a consequence, those of skill in the art will recognize a need to overcome the particular challenges presented by the current solutions to manipulation of encoded time-based media.

As an illustrative example only, those of skill in the art should recognize the below comparison between DEVSA and other somewhat related data types.

The most common data type on computers (originally) was or involved numbers. This problem was well solved in the 1950s on computers and as a material example of this success one can buy a nice calculator today for $9.95 at a local non-specialty store. As another example, both Lotus® and now Excel® software systems now solve most data display problems on the desktop as far as numbers are concerned.

Today the most common data type on computers is text. Text is a one-dimensional array of data: a sequence of characters. That is, the characters have an X component (no Y or other component). All that matters is their sequence. The way in which the characters are displayed is the choice of the user. It could be on an 8×10 inch page, on a scroll, on a ticker tape, in a circle or a spiral. The format, font type, font size, margins, etc. are all functions added after the fact easily because the text data type has only one dimension and places only one single logical demand on the programmer, that is, to keep the characters in the correct sequence.

More recently a somewhat more complex data type has become popular, photos or images. Photos have two dimensions: X and Y. A photo has a set of pixels arranged in a fixed X-Y plane and the relationship among those pixels does not change. Thus, those of skill in the art will recognize that the photo can be treated as a single object, fixed in time and manipulated accordingly.

While techniques have been developed to allow one to “edit” photos by cropping, brightening, changing tone, etc., those techniques require one to make a new data object, a new “photo” (a newly saved image), in order to store and/or retrieve this changed image. This changed image retains the same restrictions as the original: if one user wants to “edit” the image, the user needs to change the image and re-save it. It turns out that there is little “size”, “space”, or “time” penalty to that approach to photos because, compared to DEVSA, images are relatively small and fixed data objects.

In summary, DEVSA should be understood as a type of data with very different characteristics from data representing numbers, text, photos or other commonly found data types. Recognizing these differences and their impacts is fundamental to the proposed invention. As a consequence, an extension of ideas and techniques that have been applied to those other, substantially less complex data types have no corollary to those conceptions and solutions noted below. The present invention provides a new manner of (and a new solution for) dealing with DEVSA type data that both overcomes the detriments represented by such data noted above, and results in a substantial improvement demonstrated via the present system and method.

The present invention also recognizes the earlier-discussed need for a system to manage and use DEVSA data in a variety of ways while providing extremely rapid response to user input without changing the underlying DEVSA data.

What is also needed is a new manner of dealing with DEVSA that overcomes the challenges inherent in such data and that enables immediate and timely response to DEVSA data, and especially that DEVSA data and time-based media in general that is amended-or-updated on a continual or rapidly changing basis.

What is not appreciated by the related art is the fundamental data problem involving DEVSA and current systems for manipulating the same in a consumer responsive manner.

What is also not appreciated by the related art is the need for providing a data model that accommodates (effectively) all present modern needs involving high speed and high volume video data manipulation and usages.

What is also needed by those of skill in the art is a new manner of dealing with what we are referring to as social browsing details among multiple DEVSA views without changing an underlying video media content and which additionally takes into account the time-variant nature of the incorporated metadata.

Accordingly, there is a need for an improved system and method for social browsing of video content that allows an increased user freedom to upload, deep tag, enter synchronized comments upon and access content while improving informational display for all users.

### SUMMARY OF THE INVENTION

The present invention proposes a response to the detriments noted above.

Another proposal of this invention is to provide extremely easy-to-use network-based tools for individuals, who may be professional experts or may be amateur consumers (both are referred to herein as users or editors), to upload their videos and accompanying audio and other data (hereinafter called videos) to the Internet, to “edit”, deep tag, and comment synchronously or socially browse their videos in multiple ways and to share those edited, tagged, commented, browsed videos with others to the extent the editor chooses.

Another proposal of the present invention is to provide a variety of methods and tools including user interfaces, programming models, data models, algorithms, etc. within a client/server software and hardware architectural model, often an Internet-style model, which allow users to more effectively search for, discover and preview and view videos and other time-based media in order to chose and locate sub-segments in time that are of particular interest to them; further to assist others in doing so as well and further to introduce deep tags and synchronous comments to be shared with others on selected sections of the videos.

Another proposal of the invention includes an editing capability that includes, but is not limited to, functions such as abilities to add video titles, captions and labels for sub-segments in time of the video, lighting transitions and other visual effects as well as interpolation, smoothing, cropping and other video processing techniques, both under user-control and automatically.

Another proposal of the present invention is to provide a system for editing videos for private use of the originator or that may be shared with others in whole or in part according to permissions established by the originator, with different privacy settings applying to different time sub-segments of the video.

Another proposal of the present invention is to provide an editing system wherein if users or editors desire, multiple versions are easily created of a video targeted to specific sub-audiences based, for example, on the type of display device used by such sub-audience.

Another proposal of the present invention is to reduce the dependencies on the user's computer or other device, to avoid long user learning curves, and to reduce the need for the user to purchase new desktop software and hardware. To meet this alternative proposal, all video processing and storage takes place on powerful and reliable server computers accessible via the Internet or similar networks.

Another proposal of the present invention is to provide a social browsing system capable of coping with future advances in consumer or network-based electronics and readily permitting migration of certain software and hardware functions from central servers to consumer electronics including personal computers and digital video recorders or to network-based electronics such as transcoders at the edge of a wireless or cable video-on-demand network without substantive change to the solutions described herein.

Another proposal of the present invention is that videos and associated data linked with the video content may be made available to viewers across multiple types of electronic devices and which are linked via data networks of variable quality and speed, wherein, depending on the needs of that user and that device and the qualities of the network, the video may be delivered as a real-time stream or downloaded in encoded form to the device to be played-back on the device at a later time.

Another proposal of the present invention is to accomplish all of these and other capabilities in a manner that provides for efficient and cost-effective information systems design and management.

Another proposal of the present invention is to provide an improved video operation system with improved user interaction over the Internet.

Another proposal of the present invention is to provide an improved system and data model for shared viewing and editing of a time-based media that has been encoded in a standard and recognized manner and optionally may be encoded in more than one manner.

Another proposal of the present invention is to provide a system, data model, and architecture that enable comments and tags synchronized with DEVSA as it extends through time.

Another alternative proposal of the present invention is to enable a system for synchronous commenting on and deep tagging video data to identify a specific user, in a specific hierarchy, in a specific modality (soccer, kids, fun, location, family, etc.) while enabling a sharable or defined group interaction.

The present invention relates to an easy-to-use web-based system for enabling multiple-user social browsing of underlying video/DEVSA media content. A plurality of user interfaces are employed linked with one or more underlying programming modules and controlling algorithms. A data model is similarly supported and used for storing and managing DEVSA plus related metadata including complex social commenting and details regarding a particular video set of interest.

An overarching proposal of the present invention is to leverage the fact that multiple users may view the same videos via the Internet, or other means, and have similar experiences such that sharing of those experiences will bring mutual value. Another proposal of the present invention is to make use of both active and passive usage data to inform and guide the viewing experiences of others.

In one aspect of the present invention the system applies an “interest intensity” concept to time-based media to improve speed of media clip and sub-clip discovery.

As used in the present invention, the new term “interest intensity” is needed to describe a novel concept which flows from the time-sequenced nature of the DEVSA as discussed herein and the abilities to edit video as described in the referenced video editing patent application and the abilities to “deep tag” and synchronously comment upon sub-segments of the video as described in the incorporated visual browsing, deep tagging, and synchronized commenting patent applications identified herein.

“Interest intensity” is a new metric that incorporates multivariate indicators (visual, sound, etc.) which indicate not only potential interest matched to a user or group of users (as described below) but also the internal time structure of the DEVSA or video such that different sub-segments of the video may have different levels of interest intensity. In fact the interest intensity is inherently a continuously variable function of time throughout the video. Thus it can be called time-dependent interest intensity.

The concept of measuring, tracking and analyzing users' viewing behaviors is not novel but has been known for decades. The concept of interest intensity as introduced herein can be distinguished from prior forms of measuring user viewing interest by the fact that a range of new metrics are introduced including PDLs, deep tags, synchronized comments, visual browsing behaviors and social browsing behaviors. In order to explain how these new metrics can be used, consider the example of a user who watched all of a 3 minute video one time but read 4 deep tags placed on the second minute but none of the 3 deep tags placed in the first minute and none of the 5 deep tags placed in the third minute. The interest intensity concept introduced herein allows us to recognize the above user's much greater interest in the second minute of the video even though he watched the whole video once. Furthermore the manner in which metadata/PDLs are managed separately from the DEVSA and the fact that the DEVSA is not modified by user behaviors allows more precise and statistically meaningful data collection and analysis. The point being that if the video is not stable, the statistics are not stable either.

The interest intensity is specific to an individual user or specified group of users given that user's or group's profile and usage history. Given a moderately large number of users with diverse viewing histories, the interest intensity for each user or specified group for each video will become increasing personal to that individual or group.

The interest intensity can also exist and be presented in a non-individualized or specified group form such that all users see the same interest intensity map and data of any given video unaffected by their individual profile or the profiles of those whose activities contributed data to the construction of the interest intensity data.

As used herein, the term “personal interest profile” will be used to represent the combined information compiled from the user's profile plus viewing, commenting, editing, etc. history. The use of a personal interest profile makes it as easy as possible for people to define, find, display, share, save, etc. those specific time segments of video/audio which will be of most interest to them.

“Interest” can be defined in numerous ways, many of which are newly possible due to the new systems, processes and methods introduced herein and in referenced incorporated applications. These include without limitation and for example only:
a. How often watched
b. How often synchronously commented upon
c. How often added to compilations
d. How often shared
e. Positive/negative ratings
f. Number of similar deep tags used on other videos
g. How often returned in searches
h. Video length
i. Addition of soundtrack
j. Quality of video
k. Speed watched by each user: slow motion, fast-forward, etc.
l. Number of deep tags read, forwarded, etc.
m. Number of synchronized comments read, forwarded, etc.
n. Time spent in visual browsing activity
o. Time spent in social browsing activity

It should be noted that in each of these areas it should be possible to set “interest intensity” values such as “Exceptional”, “Very”, “Greater than 8 on a scale of 10”, etc. The system should also be able to define interests within multiple, parallel hierarchies of categories or by search terms such as “sports+soccer+kids+goals+Lancaster+PA”.

The present invention also envisions that while we anticipate being able to serve such affinity groupings to the user based on previous experience/history, the user will also be able to define these groups themselves either within a single session or as part of a saved preference.

Additionally, the present invention envisions that the user should be able to reference communities of interest whose standards of interest intensity the viewer wishes to use, e.g. “Sporting Events” or “European Travel,” and by membership within the community or group, share in the filtering defined by the group itself, both according to topic, as well as other defined criteria. Defined criteria would likely be managed either passively by the activity of the group members as a whole, or actively by group owners in conjunction with group members.

This will include monitoring usage in the broad senses described above and below and being able to report such usage mapped against user profile categories either as reported by the user or as determined by the system by monitoring and analyzing and storing individual user behavior and relating patterns of behaviors among users. An example of a related pattern is that if user 1 enjoyed videos D, K, P and R, when the analysis shows that user 2 enjoyed videos D, P, and R, and that users 1 and 2 belong to the same interest group, it is likely that user 2 will also enjoy video K.

Finally, the present invention envisions and anticipates granting access to activity data to our members as much as possible. The very nature of social activity networks is predicated upon a high degree of visibility of data by the users so they can understand and affect the implications of the activity themselves. It is also envisioned, that by allowing users to access data filters such as “Show me clips or segments that are watched by other members with an interest in “sports+soccer+kids+goals+Lancaster+PA” the invention may allow the user to not only search the videos themselves, but also the activity generated by the users while interacting with the videos thereby speeding user operation and efficiency.

What is additionally proposed for the present invention is a new way for managing, storing, manipulating, operating with and delivering, etc. DEVSA data stored in a recognized manner using playback decision tracking, that is tracking the decisions of users of the manner in which they wish the videos to be played back which may take the form of Playback Decision Lists (PDLs) which are time-dependent metadata co-linked to particular DEVSA data.

Another proposal of the present invention is to provide a data system and operational model that enables generation and tracking of multiple and independent (hierarchical) layers of time-dependent metadata that are stored in a manner linked with video data that affect the way the video is played back to a user at a specific time and place without changing the underlying stored DEVSA.

It is another proposal of the present invention to provide a system, method, and operational model that tracks via time-dependent metadata (via play back decision track or PDLs) individual user preferences on how to view video.

Another proposal of the present invention is to enable a system for deep tagging video data to identify a specific user, in a specific hierarchy, in a specific modality (soccer, kids, fun, location, family, etc) while enabling a sharable or defined group interaction.

Another proposal of the present invention is to enable a operative system that determines playback decision lists (PDLs) and enables their operation both in real-time on-line viewing of DEVSA data and also enables sending the PDL logic to an end-user device for execution on that local device, when the DEVSA is stored on or delivered to that end-user device, to minimize the total bit transfer at each viewing event thereby further minimizing response time and data transfer.

### BRIEF DESCRIPTION OF THE DRAWINGS

FIG. 1 represents an illustrative flow diagram for an operational system and architectural model for one aspect of the present invention.

FIG. 2 represents an illustrative flow diagram of an interactive system and data model for shared viewing and editing of encoded time-based media enabling a smooth interaction between a video media user and underlying stored DEVSA data.

FIG. 3 is an illustrative flow diagram for a web-based system for enabling and tracking editing of personal video content.

FIG. 4 is a screen image of the first page of a user's list of the user's uploaded video data.

FIG. 5 is a screen image of edit and data entry page allowing a user to “add” one or more videos to a list of videos to be edited as a group.

FIG. 6 is a screen image of an “edit” and “build” step using the present system.

FIG. 7 is a screen image of an edit display page noting three videos successively arranged in text-like formats with thumbnails roughly equally spaced in time throughout each video. The large image at upper left is a ‘blow-up’ of the current thumbnail.

FIG. 8 is a screen image of a partially edited page where selected frames with poor video have been “cut” by the user via ‘mouse’ movements.

FIG. 9 is a screen image of the original three videos where selected images of a “pool cage” have been “cut” during a video edit session. The user is now finished editing.

FIG. 10 is a screen image of the first pages of a user list of uploaded video data. The original videos have not been altered by the editing process.

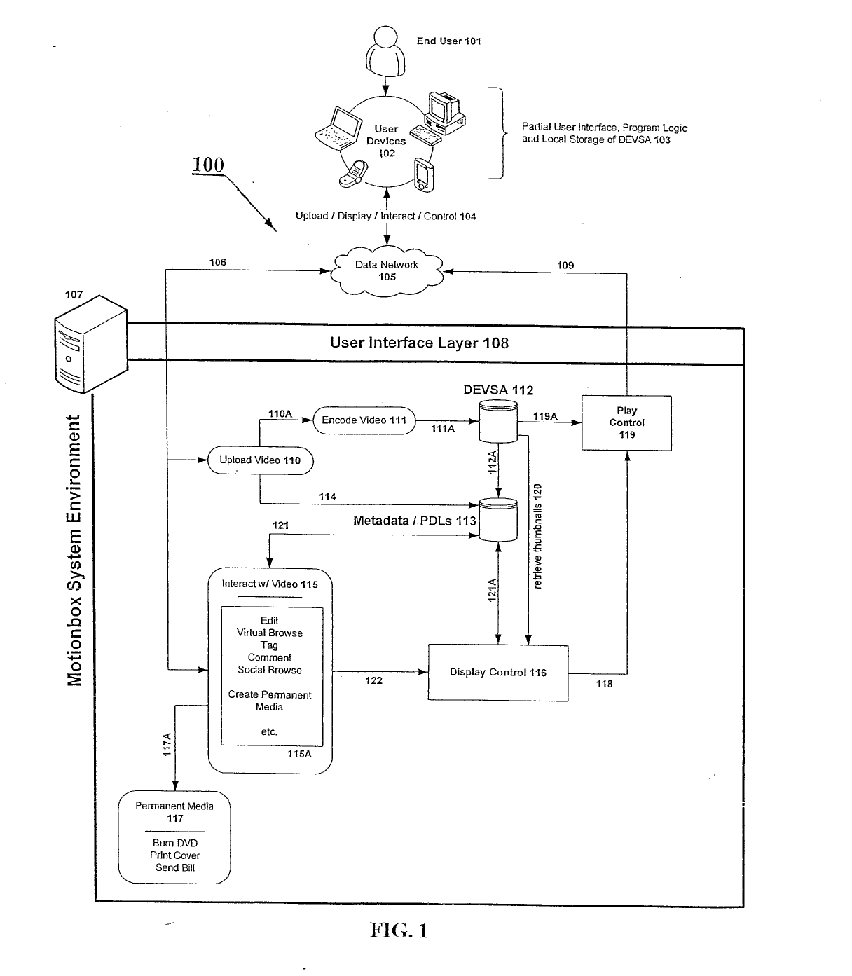

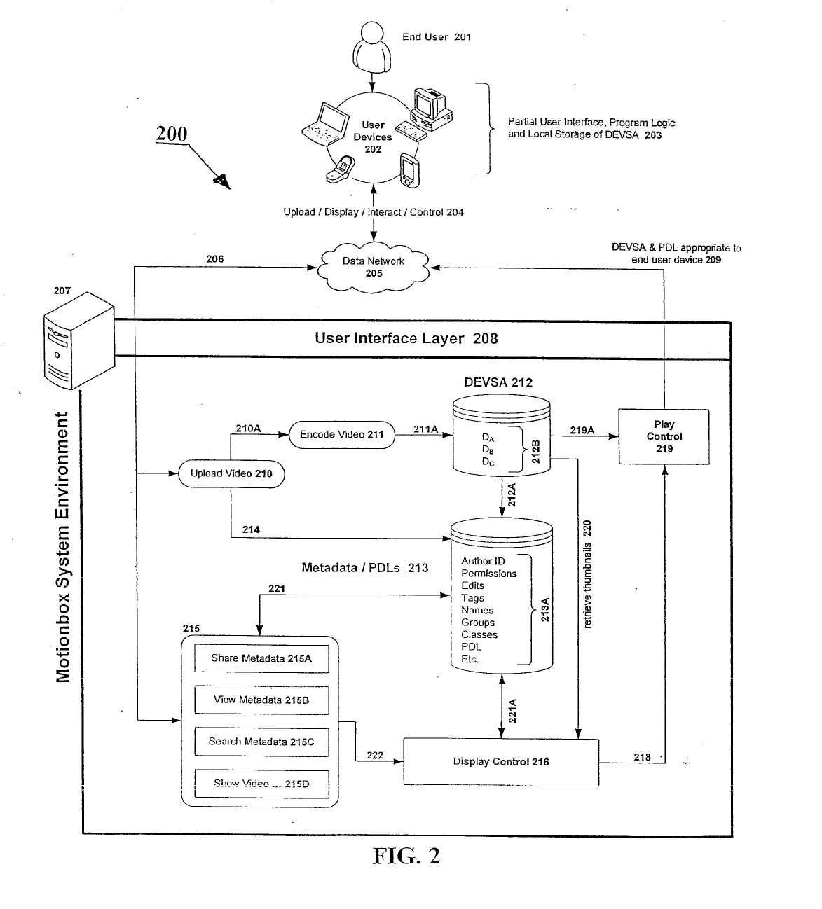

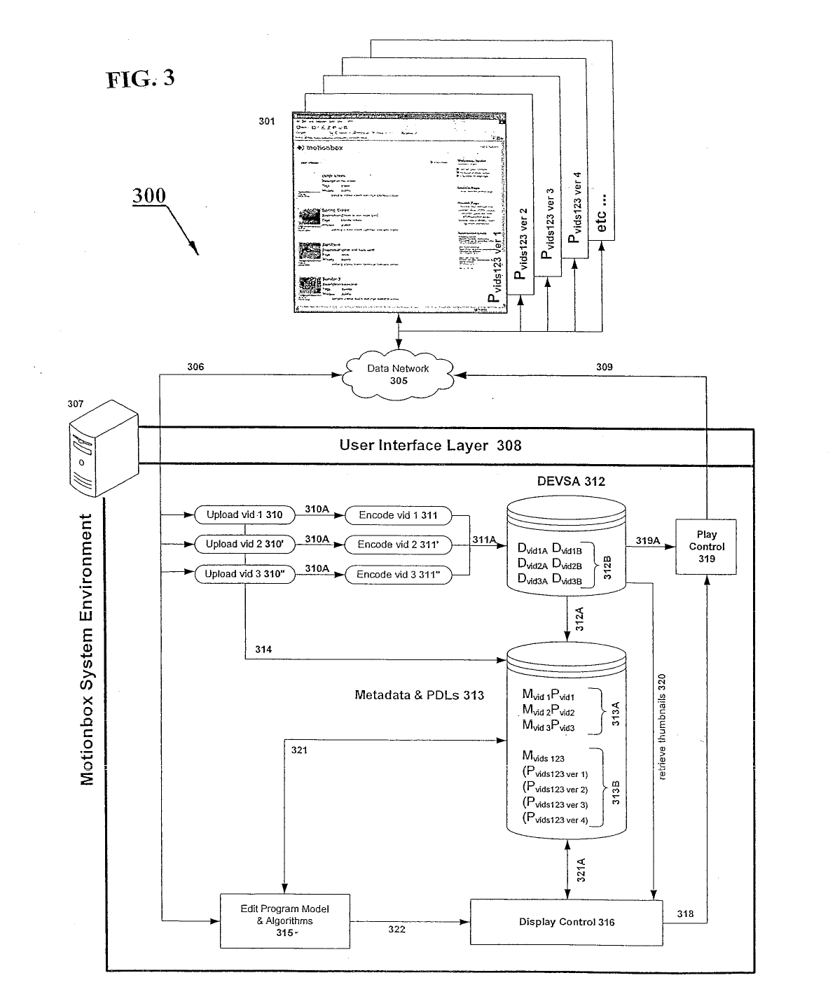

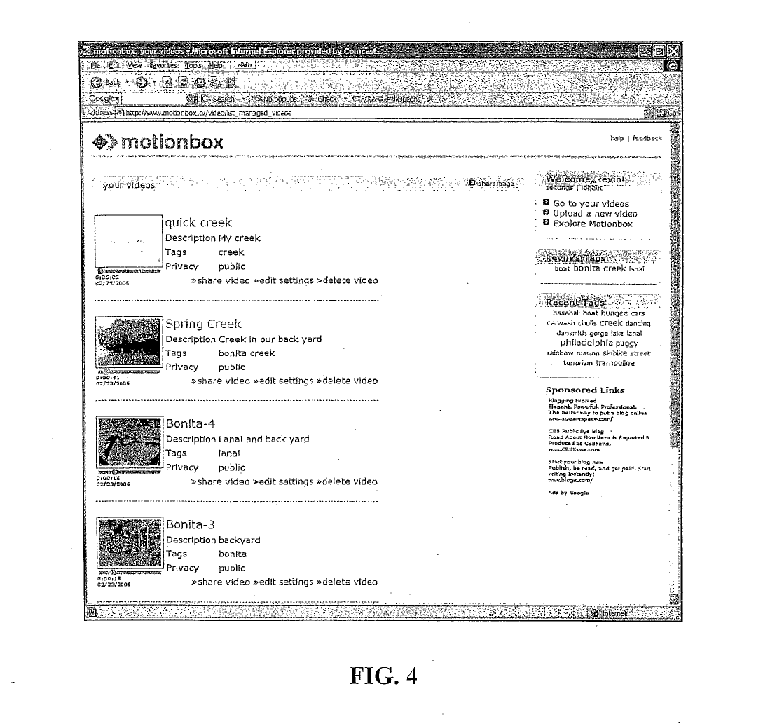

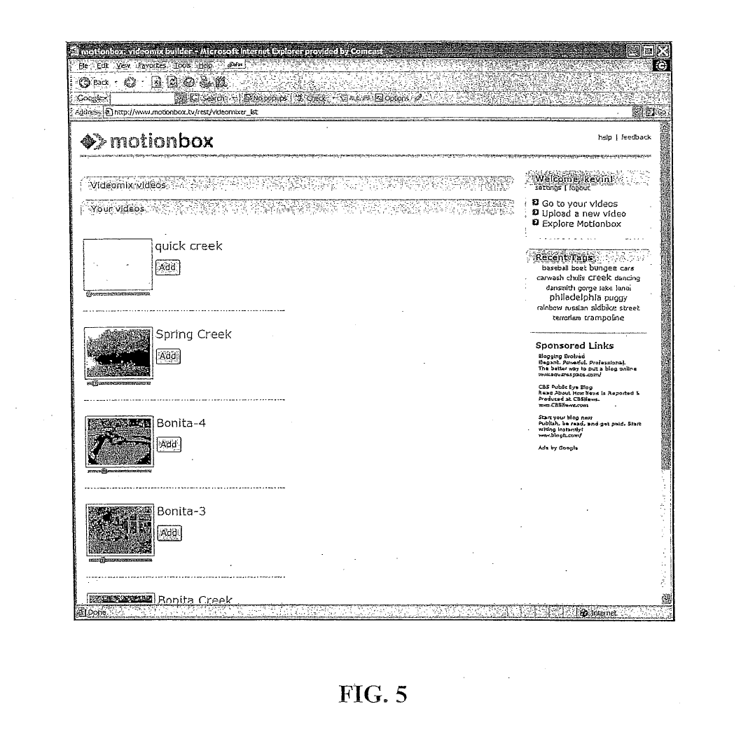

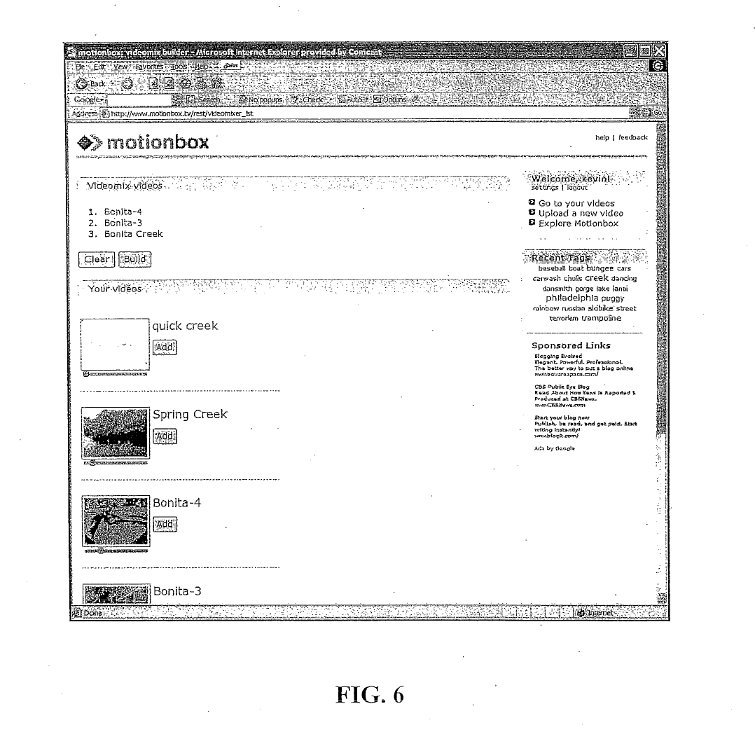

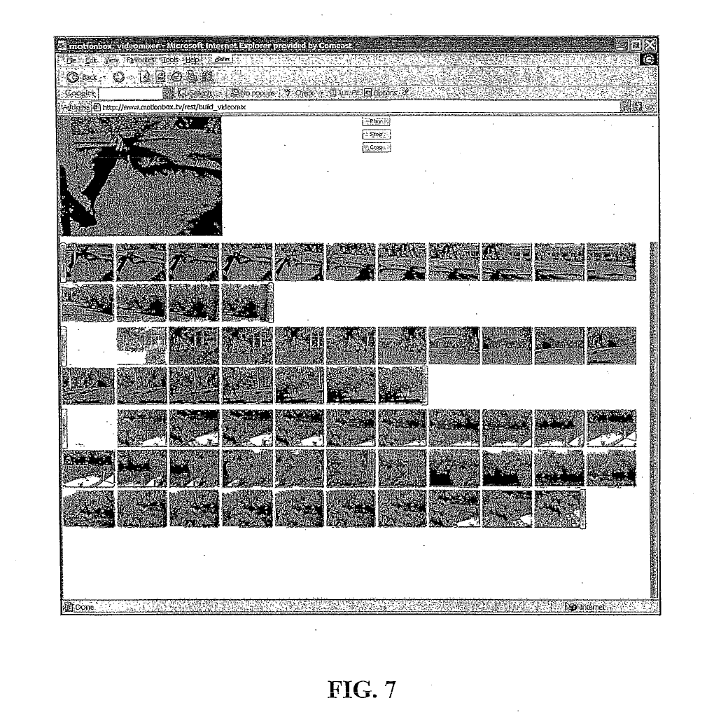

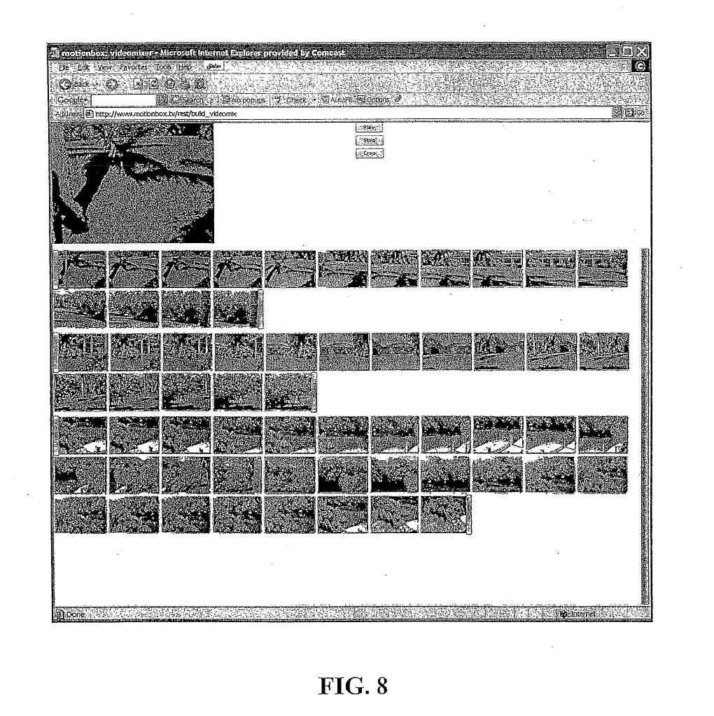

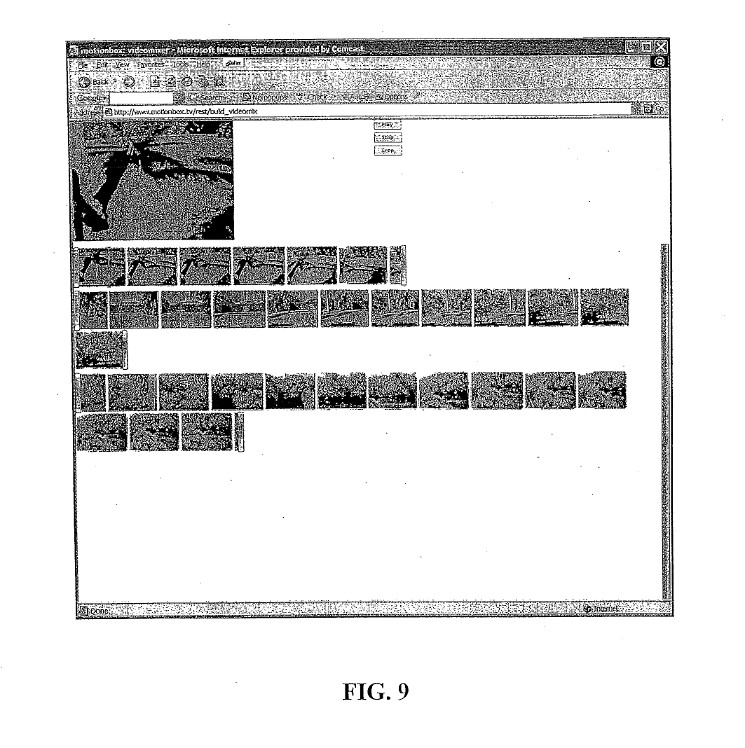

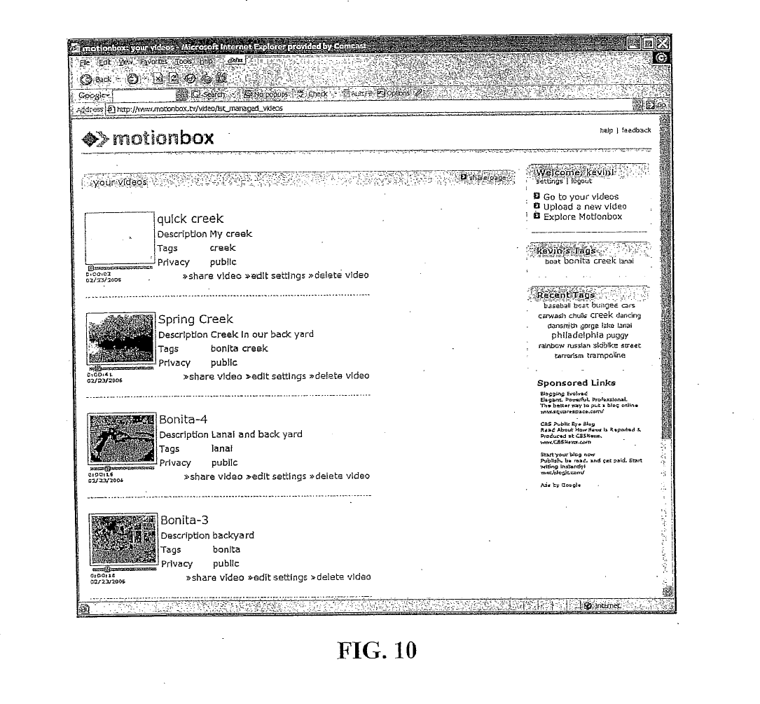

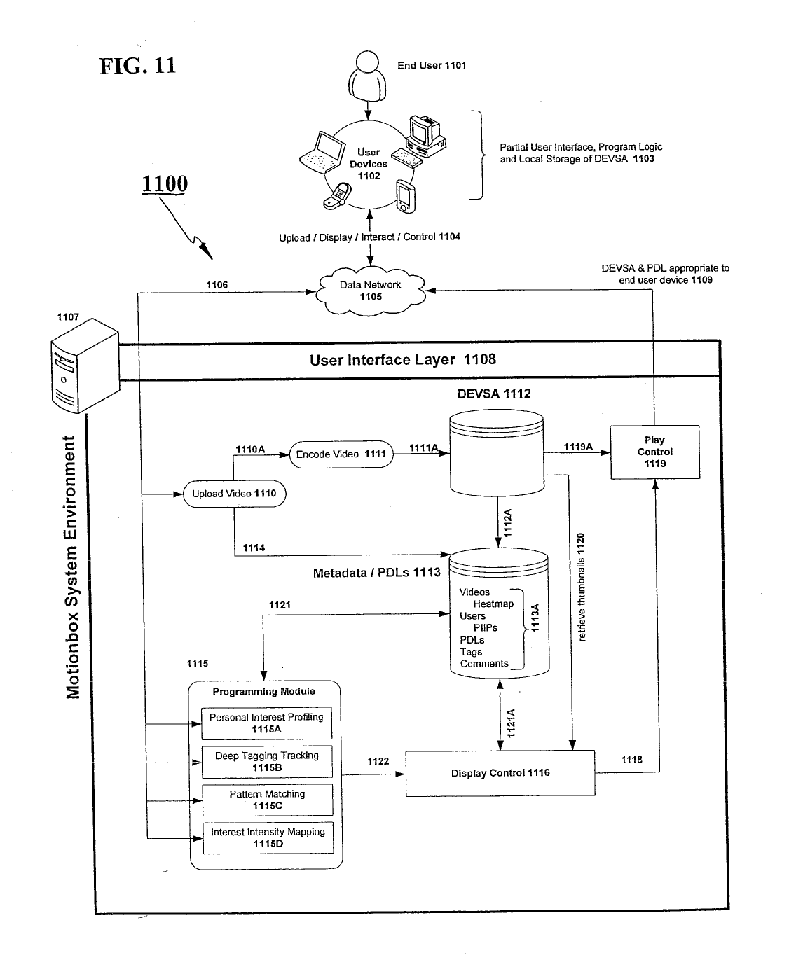

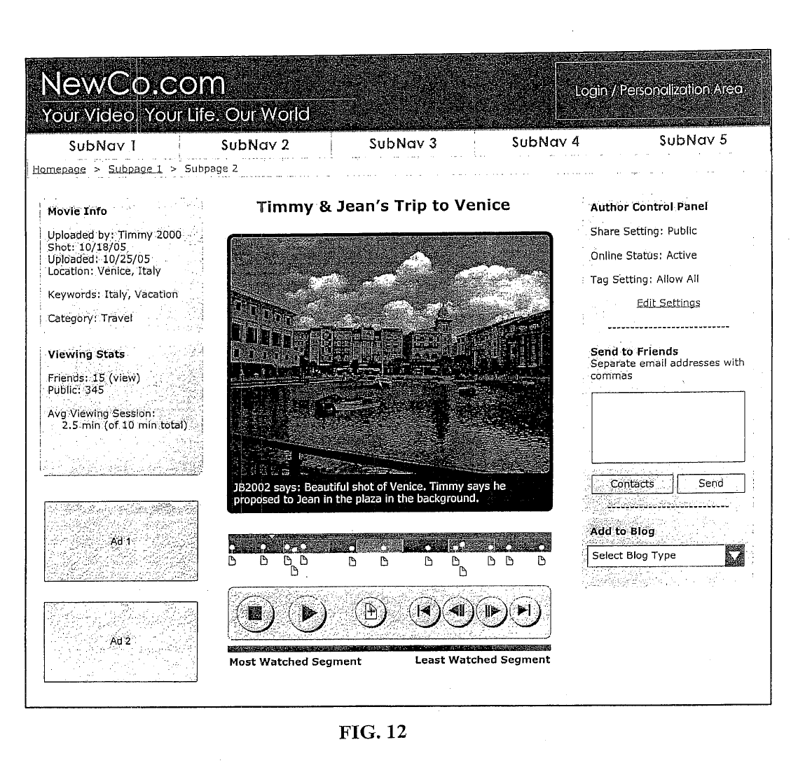

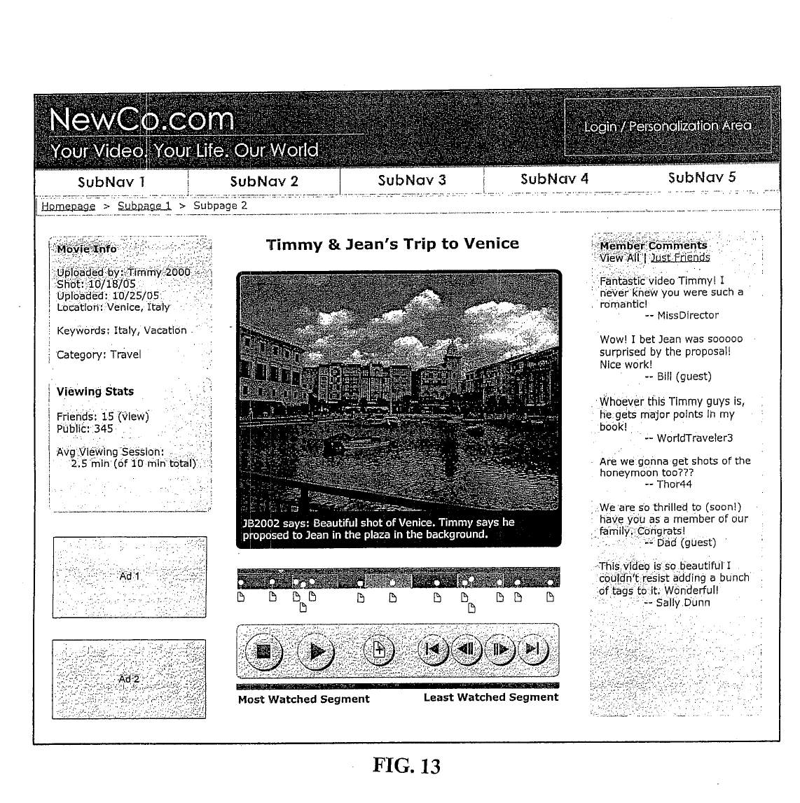

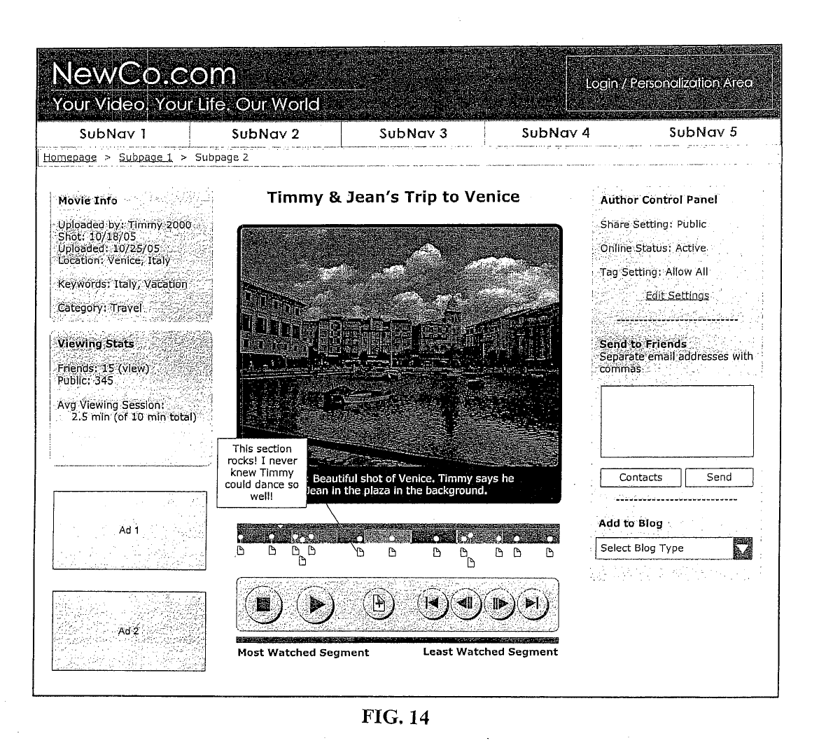

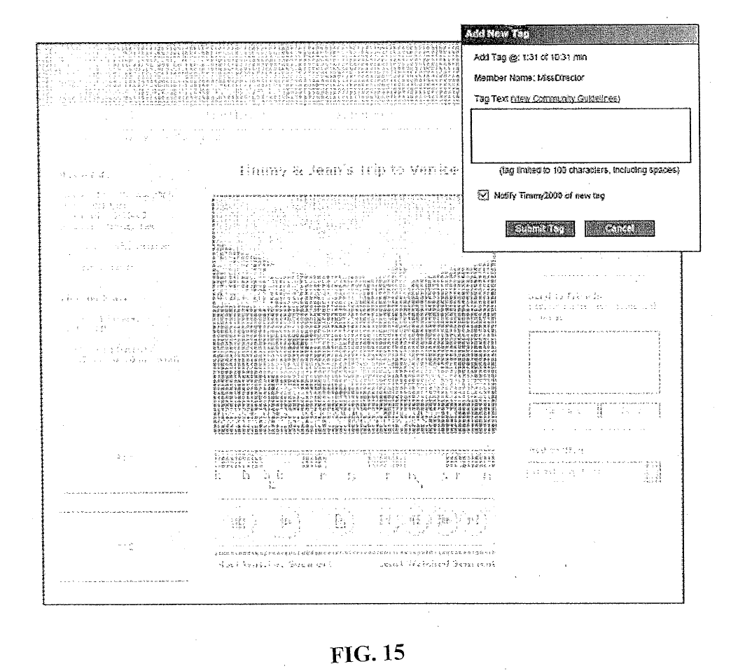

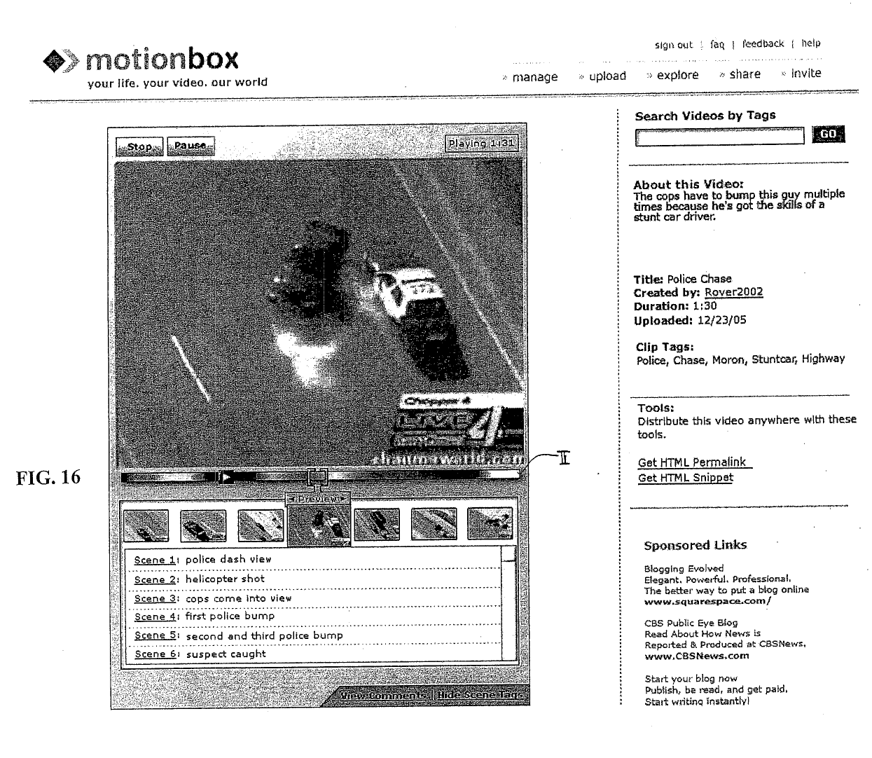

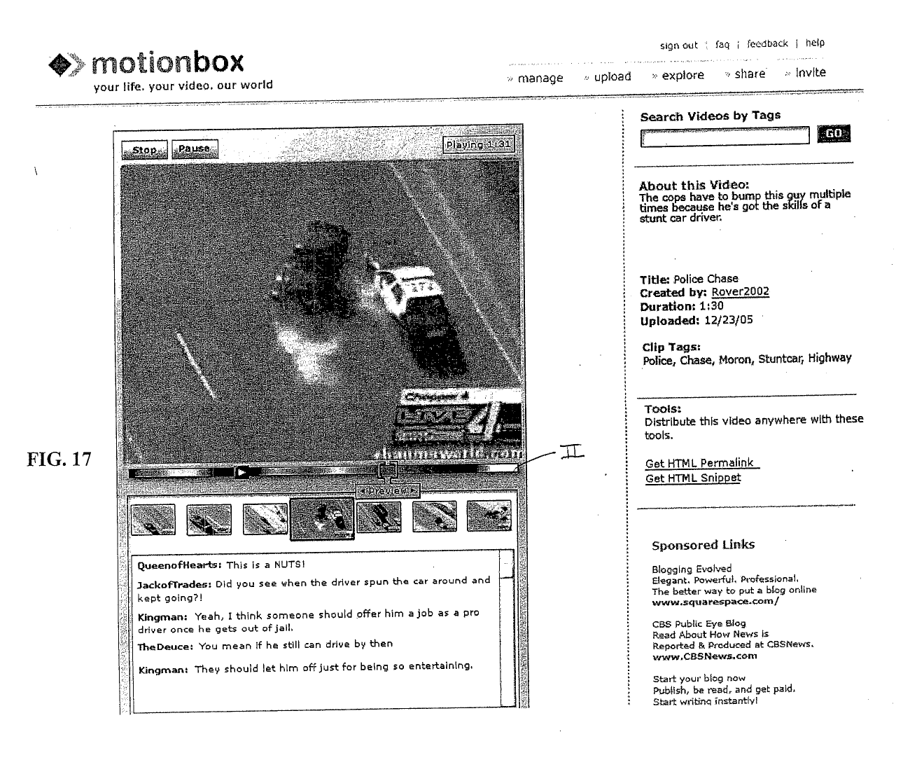

FIG. 11 is a flow diagram of a multi-user interactive system and data model for social browsing, deep tagging, interest profiling and interest intensity mapping of networked time-based media.

FIG. 12 is an image view of a user-viewed video segment with tagging and details attached.

FIG. 13 is an image view of FIG. 12 now indicating multiple member comments and social browsing with prioritization of most-least watched segments.

FIG. 14 shows, at the lower left of the large central thumbnail, a specific comment—obtained by clicking on the relevant icon.

FIG. 15 is an image view of a web page hosting a tag entry box for social commenting on a linked video image such as the image noted in FIG. 12.

FIG. 16 is an alternative image view of a social browsing system noting tagged scene labels relating to scenes of the video, and clear interest intensity indication of most to least viewed scene in a bar (shown at II) under the main image.

FIG. 17 is another alternative video image view of a social browsing system noting particular social comments for a particular scene, and an interest intensity indication of most viewed scenes.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Description of Invention: The present invention proposes a system including three major, enablingly-linked and alternatively engagable components, all driven from central servers systems.
1. A series of user interfaces;
2. An underlying programming model and algorithms; and
3. A data model.

In a preferred mode all actual video manipulation is done on the server, but local servers, consumer devices, or other effective computer systems may be engaged for operation. The “desktop” or other user interface device needs only to operate Web browser software or the equivalent, a video & audio player which can meet the server's requirements and its own internal display and operating software and be linked to the servers via the Internet or another suitable data connection. As advances in consumer electronics permit, other implementations become feasible and are described in the last section. In those alternative implementations certain functions can migrate from the servers to end-user devices or to network-based devices without changing the basic design or intent of the invention.

### The User Interface

An important component of a successful video editing system is a flexible user interface which:
1. is consistent with typical user experience but not necessarily typical video editing user interfaces,
2. will not place undue burdens on the end-user's device, and
3. is truly linked to the actual DEVSA.

A major detriment to be overcome is that the DEVSA is a four dimensional entity which needs to be represented on a two dimensional visual display, a computer screen or the display of a handheld device such as a cell phone or an iPod®.

These proposals take the approach of creating an analog of a text document made up, not of a sequence of text characters, but of a sequence of “thumbnail” frame images at selected times throughout the video. For users who express the English language as a preference, these thumbnails are displayed from left to right in sequential rows flowing downward in much the way English text is displayed in a book. (Other sequences will naturally be more appropriate for users whose written language progresses in a different manner.) A useful point is to have the thumbnails and the “flow” of the video follow a sequence similar to that of the user's written language; such as left-to-right, top-to-bottom, or right-to-left. A selected frame may be enlarged and shown above the rows for easier viewing by the user. FIG. 7 shows an example.

As a further example, a 5 minute video might be initially displayed as 15 thumbnail images spaced about 20 seconds apart in time through the video. This user interface allows the user to quickly grasp the overall structure of the video. The choice of 15 images rather than some higher or lower number is initially set by the server administrator but when desired by the user can be largely controlled by the user as he/she is comfortable with the screen resolution and size of the thumbnail image.

By means of mouse (or equivalent) or keyboard commands, the user can “zoom in” on sub-sections of the video and thus expand to, for example, 15 thumbnails covering 1 minute of video so that the thumbnails are only separated by about 4 seconds. Whenever desired, the user can “zoom-in” or “zoom-out” to adjust the time scale to meet the user's current editing or viewing needs. One approach is the so-called “slider” wherein the user highlights a selected portion of the video timeline causing that portion to be expanded (zoomed-in) causing additional, more closely placed thumbnails of just that portion to be displayed. Additionally, other view modes can be provided, for example the ability to see the created virtual clip in frame (as described herein), clip (where each segment is shown as a single unit), or traditional video editing time based views.

Additional methods of displaying thumbnails over time can also be used to meet specific user needs. For example, thumbnails may also be generated according to video characteristics such as scene transitions or changes in content (recognized via video object recognition).

The user interfaces allow drag and drop editing of different video clips with a level of ease similar to that of using a word processing application such as Microsoft Word®, but entirely within a web browser. The user can remove unwanted sections of video or insert sections from other videos in a manner analogous to the cut/copy-and-paste actions done in text documents.

A noted previously, these “drag, drop, copy, cut, paste” edit commands are stored within the data model as metadata, do not change the underlying DEVSA data, and are therefore in clear contrast with the related art.

The edit commands, deep tags and synchronized commentary can all be externally time-dependent at the user's option. As an elementary example, “If this is played between March 29 and March 31, Play Audio: “HAPPY BIRTHDAY”. Ultimately, all PDL may be externally time dependent if desired.

Other user interface representations of video streams on a two dimensional screen are also possible and could also be used without disrupting the editing capabilities described herein. One example is to arrange the page of thumbnail images in time sequence as if they were a deck of cards or a book thus creating an apparent three-dimensional object where the depth into the “deck of cards” or the “book” is a measure of time. Graphical “tabs” could appear on the cards or book pages (as on large dictionaries) which would identify the time (or other information) at that depth into the deck or book. The user could then “cut the deck” or “open the book” at places of his choosing and proceed in much the same way as described above. These somewhat different representations would not change the basic nature of the claims herein. There can be value in combining multiple such representations to aid users with diverse perception preferences or to deal with large quantities of information.

In the preceding it has been assumed that the “user” has the legal right to modify the display of the DEVSA, which may be arguably distinguished from a right to modify the DEVSA itself. There may be cases where there are users with more limited or more extensive rights. The user interface will allow the individual who introduces the video and claims full edit rights, subject to legal review, to limit or not to limit the rights of others to various viewing permissions and so-called “editing” functions (these are “modifying the display” edits noted earlier). These permissions can be adjusted within various sub-segments of the video. It is expected that the addition of deep tags and synchronized commentary by others will not generally be restricted in light of the fact that the underlying DEVSA is not compromised by these edit commands as is explained more fully below.

Before going further, and in order to fully appreciate the major innovation described in this and the related applications, it is necessary to introduce a new enabling concept which is referred to as the Playback Decision List or hereafter “PDL.” The PDL is a portion of metadata contained within a data model or operational system for manipulating related video data and for driving, for example, a flash player to play video data in a particular way without requiring a change in the underlying video data (DEVSA). This new concept of a PDL is best understood by considering its predecessor concepts that originated years ago in film production and are used today by expert film and video directors and editors.

The predecessor concept is an Edit Decision List or EDL. It is best described with reference to the production of motion pictures. In such a production many scenes are filmed, often several times each, in a sequence that has no necessary relationship to the story line of the movie. Similarly, background music, special effects, and other add-ons are produced and recorded or filmed independently. Each of those film and audio elements is carefully labeled and timed with master lists.

When these master lists are complete, the film's director and editor sit down, often for a period of months, and review each element while gradually writing down and creating and revising an EDL which is a very detailed list, second by second, of which film sequences will be spliced together in what sequence perhaps with audio added to make up the entire film. Additionally, each sequence may have internal edits required such as fade-in/out, zoom-in/out, brighten, raise audio level and so on. The end result is an EDL. Technicians use the EDL to, literally in the case of motion picture, cut and paste together the final product. Some clips are just cut and “left on the cutting room floor”. Expert production of commercial video follows a very similar approach.

The fundamental point of an EDL is that one takes segments of film or video and audio and possibly other elements and links them together to create a new stream of film or video, audio, etc. The combining is done at the film or video level, often physically. The original elements very likely were cut, edited, cropped, faded in/out, or changed in some other manner and may no longer even exist in their original form.

This EDL technique has proven to be extremely effective in producing high quality film and video. It requires a substantial commitment of human effort, typically many staff hours per hour of final media and is immensely costly. It further requires that the media elements to be edited be kept in viewable/hearable form in order to be edited properly. Such an approach is economically impossible when dealing with large quantities of consumer-produced video. The PDL concept introduced herein provides a fundamentally different way to obtain a similar end result. The final “quality” of the video will depend on the skill and talent of the editor nonetheless.

The PDL incorporates as metadata associated with the DEVSA all the edit commands, deep tags, commentary, permissions, etc. introduced by a user via a user interface (as will be discussed). It is critical to recognize that multiple users may introduce edit commands, deep tags, synchronized commentary, permissions, etc. all related to the same DEVSA without changing the underlying video data. The user interface and the structure of the PDL allow a single PDL to retrieve data from multiple DEVSA.

The result is that a user can define, for example, what is displayed as a series of clips from multiple original videos strung together into a “new” video without ever changing the original videos or creating a new DEVSA file. Since multiple users can create PDLs against the same DEVSA files, the same body of original videos can be displayed in many different ways without the need to create new DEVSA files. These “new” videos can be played from a single or from multiple DEVSA files to a variety of end-user devices through the use of software and/or hardware decoders that are commercially available. For performance or economic reasons, copies or transcodings of certain DEVSA files may be created or new DEVSA files may be rendered from an edited segment, to better serve specific end-user devices without changing the design or implementation of the invention in a significant manner.

Since multiple types of playback mechanisms are likely to be needed such as one for PCs, one for cell phones and so on, the programming model will create a “master PDL” from which algorithms can create multiple variations of the PDL suitable for each of the variety of playback mechanisms as needed. The PDL executes as a set of instructions to the video player.

As discussed earlier, in certain cases it is advantageous to download an entire encoded file in a faun suitable to a specific device type rather than stream a display in real time. In the “download” case, the system will create the file using the PDL and the DEVSA, re-encode for saving it in the appropriate format, and then send that file to the end-user device where it is stored until the user chooses to play it. This “download” case is primarily a change in the mode of delivery rather a fundamentally distinct methodology.

The crucial innovation introduced by PDL is that it controls the way the DEVSA is played to any specific user at any specific time. It is a control list for the DEVSA player (flash player/video player). All commands (edits, sequences, deep tags, comments, permissions, etc.) are executed at playback time while the underlying DEVSA does not change. This makes the PDL in stark contrast to an EDL which is a set of instructions to create a new DEVSA out of previously existing elements.

Having completed the overall supporting discussion, reference is made now to FIG. 1, an architectural review of a system model 100 for improving manipulation and operations of video and time-based DEVSA data. It should be understood, that the term “video” is sometimes used below as a term of convenience and should be interpreted to mean DEVSA, or more broadly time-based media.

In viewing the technological architecture of system model 100, those of skill in the art will recognize that an end-user 101 may employ a range of known user device types 102 (such as PCs, cell phones, PDAs, iPods et al.) to create and view DEVSA/video data.

Devices 102 include a plurality of user interfaces, operational controls, video management requirements, programming logic, local data storage for diverse DEVSA formats, all represented via capabilities 103.

Capabilities 103 enable a user of a device 102 to perform multiple interaction activities 104 relative to a data network 105. These activities 104 are dependent upon the capacities 103 of devices 102, as well as the type of data network 105 (wireless, dial, DSL, secure, non-secure, etc.).

Activities 104 including upload, display, interact, control, etc. of video, audio and other data via some form of data network 105 suited to the user device in a manner known to those of skill in the art. The user's device 102, depending on the capabilities and interactions with the other components of the overall architecture system 100, will provide 103 portions of the user interface, program logic and local data storage.

Other functions are performed within the system environment represented at 107 which typically will operate on servers at central locations while allowing for certain functionality to be distributed through data network 105 as technology allows and performance and economy suggest without changing the architecture and processes as described herein.

All interactions between system environment 107 and users 101 pass through a user interface layer 108 which provides functionality commonly found on Internet or cell phone host sites such as security, interaction with Web browsers, messaging etc. and analogous functions for other end-user devices.

As discussed, the present system 100 enables user 101 to perforin many functions, including uploading video/DEVSA, audio and other information from his end-user device 102 via data network 105 into system environment 107 via a first data path 106.

First data path 106 enables an upload of DEVSA/video via program logic upload process loop 110. Upload process loop 110 manages the uploading process which can take a range of forms.

For example, in uploading video/DEVSA from a cell phone, the upload process 110 can be via emailing a file via interactions 104 and data network 105. In a second example, for video captured by a video camera, the video may be transferred from the camera to the user's PC (both user devices 102) and then uploaded from the PC to system environment 107 web site via the Internet in real time or as a background process or as a file transfer. Physical transmission of media is also possible.

During system operation, after a successful upload via uploading process loop 110, each video is associated with a particular user 101 and assigned a unique user and upload and video identifier, and passed via pathway 110A to an encode video process system 111 where it is encoded into one or more standard forms as determined by the system administrators or in response to a user request. The encoded video/DEVSA then passes via conduit 111A to storage in the DEVSA storage files 112. At this time, the uploaded, encoded and stored DEVSA data can be manipulated for additional and different display (as will be discussed), without underlying change. As will be more fully discussed below, the present data system 100 may display DEVSA in multiple ways employing a unique player decision list (PDL) for tracking edit commands as metadata without having to re-save, and re-revise, and otherwise modify the initially saved DEVSA.

Additionally, and as can be viewed from FIG. 1, during the upload (105-106-110), encodation (110A-111), and storage (111A-112) processes stages of system 100; a variety of “metadata” is created about the DEVSA including user ID, video ID, timing information, encoding information including the number and types of encodings, access information, and many other types of metadata, all of which passes via communication paths 114 and 112A to the metadata/PDL storage facility (ies) 113. There may be more than one metadata/PDL storage facility. As will be later discussed, the PDL drives the software controller for the video player on the user device via display control 116/play control 119 (as will be discussed).

Such metadata will be used repeatedly and in a variety of combinations with other information to manage and display the DEVSA combined with the metadata and other information to meet a range of user requirements. The present system also envisions a controlled capacity to re-encode a revised DEVSA video data set without departing from the scope and spirit of the present invention.

It is expected that many users and others including system administrators will upload (over time) many DEVSA to system environment 107 so that a large library of DEVSA (stored in storage 112) and associated metadata (stored in storage 113) will be created by the process described above.

Following the same data path 106 users can employ a variety of functions generally noted by interaction with video module 115. Several types of functionalities 115A are identified as examples within interact with video module 115; including editing, visual browsing, commenting, social browsing, etc. Some of these functions are described in related applications. These functions include the user-controlled design and production of permanent DEVSA media such as DVDs and associated printing and billing actions 117 via a direct data pathway 117A, as noted. It should be noted that there is a direct data path between the DEVSA files 112 and the functions in 117 (not shown in the Figure for reasons of readability.)

Many of the other functions 115A are targeted at online and interactive display of video and other information via data networks. The functions 115 interact with users via communication path 106; and it should be recognized that functions 115A use, create, and store metadata 113 via path 121.

User displays are generated by the functions 115/115A via path 122 to a display control 116, which merges additional metadata via path 121A, thumbnails (still images derived from videos) from 112 via paths 120.

Thumbnail images are created during encoding process 111 and optionally as a real time process acting on the DEVSA without modifying the DEVSA triggered by one of the functions 115/115A (play, edit, comment, etc.).

Logically the thumbnails are part of the DEVSA, not part of the metadata, but they may be alternatively and adaptively stored as part of metadata in 113. An output of display control 116 passes via pathway 118 to play control 119 that merges the actual DEVSA from storage 112 via pathway 119A and sends the information to the data network 105 via pathway 109.

Since various end-user devices 102 have distinct requirements, multiple play control modules may easily be implemented in parallel to serve distinct device types. It is also envisioned, that distinct play control modules 119 may merge distinct DEVSA files of the same original video and audio with different encoding via 119A depending on the type of device being supported.

It is important to note that interactive functions 115/115A do not link directly to the DEVSA files stored at 112, only to the metadata/PDL files stored at 113. The display control function 116 links to the DEVSA files 112 only to retrieve still images. A major purpose of this architecture within system 100, is that the DEVSA, once encoded, is preferably not manipulated or changed—thereby avoiding the earlier noted concerns with repeated decoding, re-encoding and re-saving. All interactive capabilities are applied at the time of play control 119 as a read-only process on the DEVSA and transmitted back to user 110 via pathway 109.

Those with skill in the art should recognize that PDLs and other metadata as discussed herein can apply not only to real time playback of videos and other time-based media but also to the non-real-time playback of such media such as might be employed in the creation of permanent media such as DVDs.

Referring now to FIG. 2, in a manner similar to that discussed with FIG. 1, here an electronic system, integrated user interface, programming module and data model 200 describes the likely flows of information and control among various components noted therein. Again, as noted earlier, the term “video” is sometimes used below as a term of convenience and should be interpreted by those of skill in the art to mean DEVSA.

Here, an end-user 201 may optionally employ a range of user device types 202 such as PCs, cell phones, iPods etc. which provide user 201 with the ability to perform multiple activities 204 including upload, display, interact, control, etc. of video, audio and other data via some form of a data network 205 suited to the particular user device 202.

User devices 202, depending on their capabilities and interactions with the other components of the overall architecture for proper functioning, will provide local 203 portions of the user interface, program logic and local data storage, etc., as will also be discussed.

Other functions are performed within the proposed system environment 207 which typically operates on one or more servers at central locations while allowing for certain functionality to be distributed through the data network as technology allows and performance and economy suggest without changing the program or data models and processes as described herein.

As shown, interactions between system environment 207 and users 201 pass through a user interface layer 208 which provides functionality commonly found on Internet or cell phone host sites such as security, interaction with Web browsers, messaging etc. and analogous functions for other end-user devices.

As noted earlier, users 201 may perform many functions; including video, audio and other data uploading DEVSA from user device 202 via data network 205 into system environment 207 via data path 206.

An upload video module 210 provides program logic that manages the upload process which can take a range of forms. For video from a cell phone, the upload process may be via emailing a file via user interface 208 and data network 205. For video captured by a video camera, the video can be transferred from a camera to a user's PC and then uploaded from the PC to system environment 207 via the Internet in real time or as a background process or as a file transfer. Physical transmission of media is also possible.

During operation of system 200, and after successful upload, each video is associated with a particular user 201, assigned a unique identifier, and other identifiers, and passed via path 210A to an encode video process module 211 where it is encoded into one or more standard DEVSA forms as determined by system administrators (not shown) or in response to a particular user's requests. The encoded video data then passes via pathway 211A to storage in DEVSA storage files 212.

Within DEVSA files in storage 212, multiple ways of encoding a particular video data stream are enabled; by way of example only, three distinct ways 212B, labeled D_{A}, D_{B}, D_{C} are represented. There is no significance to the use of three as an example other than to illustrate that there are various forms of DEVSA encoding and to illustrate this diversity system 200 enables adaptation to any particular format desired by a user and/or specified by system administrators.

One or more of the multiple distinct methods of encoding may be chosen for a variety of reasons. Some examples are distinct encoding formats to support distinct kinds of end-user devices (e.g., cell phones vs. PCs), encoding to enhance performance for higher and lower speed data transmission, encoding to support larger or smaller display devices. Other rationales known for differing encodation forms are possible, and again would not affect the processes or system and model 200 described herein. A critical point is that the three DEVSA files 212B labeled D_{A}, D_{B}, D_{C} are encodings of the same video and synchronized audio using differing encodation structures. As a result, it is possible to store multiple forms of the same DEVSA file in differing formats each with a single encodation process via encodation video 211.

Consequent to the upload, encode, store processes a plurality of metadata 213A is created about that particular DEVSA data stream being uploaded and encoded; including user ID, video ID, timing information, encoding information, including the number and types of encodings, access information etc. which passes by paths 214 and 212A respectively to the metadata/PDL (playback decision list) storage facilities 213. Such metadata will be used repeatedly and in a variety of combinations with other information to manage and display the DEVSA combined with the metadata and other information to meet a range of user requirements.

Thus, as with the earlier embodiment shown in FIG. 1, those of skill in the art will recognize that the present invention enables a single encodation (or more if desired) but many metadata details about how the encoded DEVSA media is to be displayed, managed, parsed, and otherwise processed.

It is expected that many users and others including system administrators (not shown) will upload many videos to system environment 207 so that a large library of DEVSA and associated metadata will be created by the process described above.

Following the same data path 206, users 201 may employ a variety of program logic functions 215 which use, create, store, search, and interact with the metadata in a variety of ways a few of which are listed as examples including share metadata 215A, view metadata 215B, search metadata 215C, show video 215D etc. These data interactions utilize data path 221 to the metadata/PDL databases 213. A major functional portion of the metadata is Playback Decision Lists (PDLs) that are described in detail in other, parallel submissions, each incorporated fully by reference herein. PDLs, along with other metadata, control how the DEVSA is played back to users and may be employed in various settings.

As was shown in FIG. 2 many of the other functions in program logic box 215 are targeted at online and interactive display of video and other information via data networks. As was also shown in FIG. 1, but not indicated here, similar combinations of metadata and DEVSA can be used to create permanent media.

Thus, those of skill in the art will recognize that the present disclosure also enables a business method for operating a user interface 208.

It is the wide variety of metadata, including PDLs, created and then stored which controls the playback of video, not a manipulation of the underlying and encoded DEVSA data.

In general the metadata will not be dependent on the type of end-user device utilized for video upload or display although such dependence is not excluded from the present disclosure.

The metadata does not need to incorporate knowledge of the encoded DEVSA data other than its identifiers, its length in clock time, its particular encodings, knowledge of who is allowed to see it, edit it, comment on it, etc. No knowledge of the actual images or sounds contained within the DEVSA is required to be included in the metadata for these processes to work. While this point is of particular novelty, this enabling system 200 is more fully illustrative.

Such knowledge of the actual images or sounds contained within the DEVSA while not necessary for the operation of the current system enables enhanced functionalities. Those with skill in the art will recognize that such additional knowledge is readily obtained by means of techniques including voice recognition, image and face recognition as well as similar technologies. The new results of those technologies can provide additional knowledge that can then be integrated with the range of metadata discussed previously to provide enhanced information to users within the context of the present invention. The fact that this new form of information was derived from the contents of the encoded time-based media does not imply that the varied edit, playback and other media manipulation techniques discussed previously required any decoding and re-encoding of the DEVSA. Such knowledge of the internal contents of the encoded time-based media can be obtained by decoding with no need to re-encode the original video so the basic premises are not compromised.

User displays are generated by functions 215 via path 222 to display control 216 which merges additional metadata via path 221A, thumbnails (still images derived from videos) from DEVSA storage 212 via pathway 220. (Note that the thumbnail images are not part of the metadata but are derived directly from the DEVSA during the encoding process 211 and/or as a real time process acting on the DEVSA without modifying the DEVSA triggered by one of the functions 215 or by some other process. Logically the thumbnails are part of the DEVSA, not part of the metadata stored at 213, but alternative physical storage arrangements are envisioned herein without departing from the scope and spirit of the present invention.

An output of display control 216 passes via pathways 218 to play controller 219, which merges the actual DEVSA from storage 212 via data path 219A and sends the information to the data network via 209. Since various end-user devices have distinct requirements, multiple play control modules may be implemented in parallel to serve distinct device types and enhance overall response to user requests for services.

Depending on the specific end-user device to receive the DEVSA, the data network it is to traverse and other potential decision factors such as the availability of remote storage, at playback time distinct play control modules will utilize distinct DEVSA such as files D_{A}, D_{B}, or D_{C} via 219A.

The metadata transmitted from display control 216 via 218 to the play control 219 includes instructions to play control 219 regarding how it should actually play the stored DEVSA data and which encoding to use.

The following is a sample of a PDL—playback decision list—and a tracking of user decisions in metadata on how to display the DEVSA data. Note that two distinct videos (for example) are included here to be played as if they were one. A simple example of typical instructions might be:

### Instruction (Exemplary):

Play video 174569, encoding b, time 23 to 47 seconds after start:
Fade in for first 2 seconds—personal decision made for tracking as metadata on PDL.
Increase contrast throughout—personal decision made for PDL.
Fade out last 2 seconds—personal decision made for PDL. Play video 174569, encoding b, time 96 to 144 seconds after start
Fade in for first 2 seconds—personal decision made for PDL.
Increase brightness throughout—personal decision made for PDL.
Fade out last 2 seconds—personal decision made for PDL.

Play video 174573 (a different video), encoding b, time 45 to 74 seconds after start
Fade in for first 2 seconds—personal decision for PDL.
Enhance color AND reduce brightness throughout, personal decision for PDL.
Fade out last 2 seconds—personal decision for PDL.

The playback decision list (PDLs) instructions are those selected using the program logic functions 215 by users who are typically, but not always, the originator of the video. Note that the videos may have been played “as one” and then have had applied changes (PDLs in metadata) to the visual video impression and unwanted video pieces eliminated. Nonetheless the encoded DEVSA has not been changed or overwritten, thereby minimizing risk of corruption, the expense of re-encoding has been avoided and a quick review and co-sharing of the same (or multiples of) video among multiple video editors and multiple video viewers has been enabled.

Much other data may be displayed to the user along with the DEVSA including metadata such as the name of the originator, the name of the video, the groups the user belongs to, the various categories the originator and others believe the video might fall into, comments made on the video as a whole or on just parts of the video, deep tags or labels on the video or parts of the video.

It is important to note that the interactive functions 215 for reviewing and using DEVSA data, do not link to the DEVSA files, only to the metadata files, it is the metadata files that back link to the DEVSA data. Thus, display control function 216 links to DEVSA files at 212 only to retrieve still images. A major purpose of this data architecture and data system 200 imagines that the DEVSA, once encoded via encodation module 211, is not manipulated or changed and hence speed and video quality are increased, computing and storage costs are reduced. All interactive capabilities are applied at the time of play control that is a read-only process on the DEVSA.

Those of skill in the art should recognize that in optional modes of the above invention each operative user may share their metadata with others, create new metadata, or re-use previously stored metadata for a particular encoded video.

Referring now to FIG. 3 an operative and editing system 300 comprises at least three major, linked components, including (a) central servers 307 which drive the overall process along a plurality of user interfaces 301 (one is shown), (b) an underlying programming model 315 housing and operatively controlling operative algorithms, and (c) a data model encompassing 312 and 313 for manipulating and controlling DEVSA and associated metadata.

Those of skill in the art should understand that all actual video manipulation is done on the server. Thus this concept depicted here envisions that a “desktop” or other user interface device need only to operate Web browser software and its own internal video player and display and operating software and be linked to servers 307 via the Internet or another suitable data network connection 305. Those of skill in the art should understand that the PDL produces a set of instructions for the components of the central system environment, any distributed portions thereof and end-user device video player and display. The PDL is generated on the server while the final execution of the instructions generally takes place on the end-user device.

As a consequence, the present discussion results in “edit-type commands” becoming a subset of the metadata described earlier.

Those of skill in the art should understand that while much of the discussion in this application is focused on video. The capabilities described herein apply equally to audio. They would also apply to many forms of graphic material, and certainly all graphic material which has been encoded in video format. Other than time-dependent functions (that is time internal to the DEVSA), they apply equally to photographic images and to text.

During operation, a user (not shown) interfaces with user interface layer 308 and system environment 307 via data network 305. A plurality of web screen shots 301 is represented as illustrated examples of the process of video image editing that is shown in greater detail with FIGS. 4 through 10.

During personal editing of content, a user (not shown) interacts with user interface layer 308 and transmits commands through data network 305 along pathway 306.

As shown a user has uploaded multiple, separate videos vid 1, vid 2, vid 3 using processes 310, 310′, 310″. Then via parallel processes 310 the three videos are encoded in process 311. In this example we show each video being encoded in two distinct formats (D_{vid1A}, B_{vid1B}) based either on system administration rules or on user requests. Via path 311A two encoded versions of each of the three videos is stored in 312 labeled respectively D_{vid1A} D_{vid1B} and so on where those videos of a specific user are retained and identified by user at grouping 312B.

It should be similarly understood, that the initial uploading steps 310 for each of the videos generate related metadata and PDLs 313 transferred to a respective storage module 313, where each user's initial metadata is individually identified in respective user groupings 313A.

Those of skill in the art will understand that multiple upload and encode steps allow users to display, review, and edit multiple videos simultaneously. Additionally, it should be readily recognized that each successive edit or change by an individual is separately tracked for each respective video for each user. When editing multiple videos like this—or just one video—the user is creating a new PDL which is a new logical object which is remembered and tracked by the system.

As will be understood, videos may be viewed, edited, and updated in parallel with synchronized comments, deep tagging and identifying.

The present system enables social browsing of others' multiple videos with synchronized commenting for a particular single video or series of individual videos.

A display control 316 receives data via paths 312A and thumbnails via path 320 for initially driving play controller 319 via pathway 318.

As is also obvious from FIG. 3, an edit program model 315 (discussed in more detail below) receives user input via pathway 306 and metadata and PDLs via pathway 321.

The edit program model 315 includes a controlling communication path 322 to display control 316. As shown, the edit program model 315 consists of sets of interactive programs and algorithms for connecting the user's requests through the aforementioned user interfaces 308 to a non-linear editing system on server 307 which in turn is linked to the overall data model (312 and 313 etc.) noted earlier in-part through PDLs and other metadata.

Since multiple types of playback mechanisms are likely to be needed such as one for PCs, one for cell phones and so on, the edit program model 315 will create a “master PDL” from which algorithms can adaptively create multiple variations of the PDL suitable for each of the variety of playback mechanisms as needed. Here, the PDL is executed by the edit program model and algorithms 315 that will also interface with the user interface layer 308 to obtain any needed information and, in turn, with the data model (See FIG. 2) which will store and manage such information.

The edit program model 315 retrieves information from the data model as needed and interfaces with the user interface layer 308 to display information to multiple users. Those of skill in the arts of electronic programming should also recognize that the edit program model 315 will also control the mode of delivery, streaming or download, of the selected videos to the end-user; as well as perform a variety of administrative and management tasks such as managing permissions, measuring usage (dependency controls, etc.), balancing loads, providing user assistance services, etc. in a manner similar to functions currently found on many Web servers.

As noted earlier the data model generally in FIGS. 1 and 2, manages the DEVSA and its associated metadata including PDLs. As discussed previously, changes to the metadata including the PDLs do not require and in general will not result in a change to the DEVSA. However for performance or economic reasons the server administrator may determine to make multiple copies of the DEVSA and to make some of the copies in a different format optimized for playback to different end-user device types. The data model noted earlier and incorporated here assures that links between the metadata associated with a given DEVSA file are not damaged by the creation of these multiple files. It is not necessary that separate copies of the metadata be made for each copy of the DEVSA; only the linkages must be maintained.

One PDL can reference and act upon multiple DEVSA. Multiple PDLs can reference and act upon a given DEVSA file. Therefore the data model takes special care to maintain the metadata to DEVSA file linkages.

Referring now to FIGS. 4-10, an alternative discussion of images 301 is discussed in order to demonstrate how the process can appear to the user in one example of how a user can “edit” DEVSA by changing the manner in which it is viewed without changing the actual DEVSA as it is stored. In FIG. 4, a user has uploaded via upload modules 310A a series of videos that are individually characterized with a thumbnail image, initial deep tagging and metadata. The first page is shown.

In FIG. 5, options ask whether to add a video or action to a user's PDL (as distinguished from a user's EDL), and a user may simply click on a “add” indicator to do so. Multiple copies of the same video may be entered as well without limit.

In FIG. 6, a user has added and edited three videos of his or her choosing to the PDL and has indicated a “build” instruction to combine all selected videos for later manipulation.

In FIG. 7, an edit display page is provided and a user can see all three selected videos in successively arranged text-like formats with thumbnails via 320 equally spaced in time (roughly) throughout each video. Here 2 lines for the first 2 videos and 3 lines for the third video just based on length. Here at the beginning and end of each video there is a vertical bar signifying the same and a user may “grab” these bars using a mouse or similar device and move left-right within the limits of the videos. A thin bar (shown in FIG. 7 about 20% into the first thumbnail of the first video) also enables and shows where an image playback is at the present time and where the large image at the top is taken from. If the user clicks on PLAY above, the video will play through all three videos without a stop until the end thus joining the three short videos into one, all without changing the DEVSA data.

In FIG. 8, a user removes certain early frames in the second two videos to correct lighting and also adjusted lighting and contrast by using metadata tools. A series of sub-images may be viewed by grouping them and pressing “Play.”

In FIG. 9 the user has continued to edit his three videos into one continuous video showing his backyard, no bad lighting scenes, no boat, no “pool cage”. It is less than half the length of the original three, plays continuously and has no bad artifacts. The three selected videos will now play as one video in the form shown in FIG. 9. The user may now give this edited “video” a new name, deep tags, comments, etc. It is important to note that no new DEVSA has been created, what the user perceives as a new “video” is the original DEVSA controlled by new PDLs, and other metadata created during the edit session described in the foregoing. The user is now finished editing in this example.

In FIG. 10, a user has returned to the initial user video page where all changes have been made via a set of PDLs and tracked by storage module 313 for ready playing in due course, all without modifying the underlying DEVSA video. His original DEVSA are just as they were in FIG. 4.

The present invention provides a highly flexible user interface and such tools are very important for successful video editing systems. The invention is also consistent with typical user experience with Internet-like interactions, but not necessarily typical video editing user interfaces. The invention will not place undue burdens on the end-user's device, and the invention truly links actual DEVSA with PDL.

Referring now to FIG. 11 that is a flow diagram of a multi-user interactive system and data model 1100 for social browsing, deep tagging, interest profiling and interest intensity mapping of networked time-based media.

This operative system comprises at least three major, linked components, all driven from central servers 1107 including (a) a plurality of user interfaces represented as user interface layer 1108 that is linked to a variety of end user devices 1102 used by end users 1101 (one is shown) via a plurality of data networks 1105 (one is shown), (b) an underlying programming model including the programming module 1115 operatively housing and controlling operative algorithms and programming, and (c) a data model or system encompassing operative modules 1112 and 1113 for manipulating and controlling stored, digitally encoded time-based media such as video and audio, DEVSA, and associated metadata.

Those of skill in the art should understand that, in the present embodiment, all actual video manipulation is done on the server. Thus, this concept depicted here envisions that a “desktop” or other user interface device need (at a minimum) only to operate Web browser software and its own internal video player and display and operating software linked to servers 1107 via the Internet or another suitable data network connection 1105. As an alternative embodiment those of skill in the art will recognize that the present system may be adapted to desktop operations under special circumstances where Internet access is not available or desirable.

The extension of similar concepts and capabilities to end-user devices is non-trivial. The separation of metadata/PDLs from DEVSA which is not modified by deep tags, synchronized comments, visual browsing tools and social browsing tools enables a system, process and method to position databases in varied physical locations without varying their logical relationships.

Thus the operational and software architecture of FIG. 11 has a form very similar to that described in earlier FIGS. 1, 2, and 3. The primary details described herein are beyond those described in the related applications listed above as cross-references occur within modules 1115 and 1113 and their interactions. The roles, actions, and capabilities of upload video 1110, encode video 1111, display control 1160, play control 1119 and DEVSA storage module 1112 are similar to those described in the discussion of the previous Figures.

Those of skill in the art should again understand that the PDL produces a set of instructions for the end user device video player and display software and hardware. In the present embodiment, the PDL is generated on the server while the final execution of the instructions generally (but not always) takes place on the end user devices 1102.

As a consequence, in such instances when the present discussion results in “edit-type commands”, those commands become a subset of the metadata described earlier.

Those of skill in the art should further understand that while much of the discussion in this application is focused on video, the capabilities described herein apply equally to audio data. The capabilities would additionally apply to many forms of graphic material, and certainly all graphic material that has been encoded in video format. Other than time-dependent functions, these capabilities apply equally to photographic images, to graphics, and to text.

During common operation, a user 1101 interfaces with user interface layer 1108 and system environment 1107 via data network 1105 and pathway 1106. In a practical sense, a plurality of screen displays would be observed by the user 1101 as user 1101 interacts with the functions operably retained within personal interest profiling 1115a, deep tagging tracking 1115b, pattern matching 1115c and/or interest intensity mapping 1115d within programming module 1115.

During operation, as user 1101 interacts with the functionalities, features, and algorithms contained in programming module 1115, programming module 1115 interacts with metadata/PDL data storage 1113 both uploading information of user inputs and downloading information about the media and about other users' activities and information. The programming module 1115 also interacts with display control 1116 in the manner discussed previously to repeatedly create new displays of media in response to user inputs and according to algorithms and functionalities that respond to metadata (both new and previously stored). Each user's activities are tracked, analyzed and stored in metadata/PDL storage module 1113 as metadata and linked to the appropriate videos, the internal time within those videos, the user's group affiliations, and such other data as may be needed to carry out the functions described herein. Specifically, metadata/PDL data storage module 1113 will store information regarding the videos and sub-segments of videos viewed, the users, the user profiles, the user viewing activities, deep tags and synchronized comments created and/or read by each user 1101 and link those tags and comments to specific time intervals internal to the specified video or other time-based media. Algorithms associated with of the components of the programming module 1115 will perform multivariate analyses of the data and employ the results of those analyses to compute a variety of useful results.

Some examples of those useful results include:
a. Personal interest profile for each user representing the combined information compiled from the user's profile plus viewing, commenting, editing, etc. history.
b. Tag tracking search analyzer which is a set of methods and tools to ease users' efforts to search for video segments with tags of interest to them as individuals or as group members.
c. Pattern matching analyzers to assist users in finding video segments of potential interest based on patterns of interests of other users with personal interest profiles as described above.
d. Interest intensity mapping which is a continuous metric within the time internal to a video of the demonstrated multiple active and passive behavior of previous viewers (including viewing behavior, tagging behavior, commenting behavior, visual and social browsing behavior) as discussed previously. Interest intensity is kept as a continuous function of time through the video (using numerical analysis techniques known to those of skill in the art of applied mathematics) not tied to any arbitrary, fixed time windows. The interest intensity can be calculated for all viewers or for various subsets of such viewers and also for all viewers as desired. Interest intensity is another form of metadata linked to the DEVSA.

Since multiple types of playback mechanisms are likely to be needed such as one for PCs, one for cell phones and so on, programming module 1115 will preferably create a “master PDL” from which algorithms, functionalities, and features can adaptively create multiple variations of the PDL suitable for each of the variety of playback mechanisms as needed. Here, as shown, the PDL is executed by programming module 1115 and will also operatively interface with user interface 1108 to obtain any needed information and, in turn, with the data model (See FIG. 2) which will store and manage such information.

During preferred operation, programming model 1115 retrieves information from the data model as needed and interfaces with user interface 1108 to display information to multiple users 1101. Those of skill in the arts of electronic programming should also recognize that programming model 1115 will optionally also control the mode of delivery, streaming or download, of the selected videos to the end user; as well as perforin a variety of administrative and management tasks such as managing permissions, measuring usage, balancing loads, providing user assistance services, etc.

Referring now to FIGS. 12-17, those of skill in the art will recognize that the present invention consists of three major, linked components, all driven from the central servers: 1. A series of user interfaces; 2. An underlying programming model and algorithms; and 3. A data model.

For reasons of performance and economics a subset of the user interface and programming model functions could be migrated to the end-user device. Further, in certain implementation alternatives, data storage and data gathering capabilities of end-user devices may be utilized.

The user interface will provide means for and encourage both originators and viewers of media to attach tags and commentary to segments and even frames. Many preformed categories will be established by the system and as users add tags new categories will automatically be created. The tags and comments entered into the will be captured by the programming module and stored in the data module where they will be searchable following methods in common use on Web sites so that subsequent users can make use of that to enhance their ability to find interesting media.

The programming module will monitor, count and store in the data module as a function of time from the start to the end of the DEVSA:
a. All episodes of users' viewing specific segments with special attention to repeat views, fast forwards, double fast forwards, commenting behavior, etc. by the same users.
b. All episodes of sharing of segments including the number of sharees and the subsequent sharing by the sharees.
c. The number of users entering and viewing deep tags and/or synchronous comments on each segment.
d. The categories within which each user views segments and the frequency thereof.
e. Use the data collected in d above to determine categories which appear to have common interest to users both individually and collectively.
f. Use the data collected in a, b, c above to create a metric of “interest” related to the multiple, hierarchical categories to which the segment belongs.
g. Provide to subsequent users a prioritized list, time-variable interest intensity map such as a variably colored bar underlying a string of thumbnails as shown in FIG. 16, or other graphical representation of the interest intensity of video segments based on all the information in a, b, c, d, e, and f to recommend to each individual user segments likely to be of high interest and couple that recommendation with thumbnails, significant tags, comments, categories and other information related to those segments in order to encourage and assist users to view additional segments which they will find more or less “interesting”.

As disclosed herein, those of skill in the art will recognize that the data module will store data as a function of time within the DEVSA related to the usage of each segment and to each user and to each category and to all tags, labels, comments, sharees, etc. and provide search capabilities against that data.

That search capability can be accessible to users, to the programming module, to system administrators and to third parties such as advertisers who wish to target audiences with specific interest profiles.

Of special interest as a result of item ‘g’ above is the ability to create a “time-dependent interest intensity” profile of a lengthier video which may have been created from multiple other videos using the PDL editing process described previously.

In contrast to the present state of the art that treats a video (more generally a DEVSA) as a single entity, and may allow tags and comments on that single entity, the related art can not break that entity down into specific, arbitrarily short segments defined by the users themselves or by the users' activities and allow users to insert tags, comments and the like attached only to that segment and then to share only that segment with their friends or with others of similar interests whether those others are known or unknown to the user. As a consequence, the present invention is substantially different from the closest known related art.

As a further contrast with the present state of the art the DEVSA for which the interest intensity is gathered and displayed can, via the metadata/PDL mechanisms described previously, be made up of portions of multiple independently loaded videos which have been edited using the process described herein and in related applications into one or more viewable video streams while leaving the originally loaded videos unchanged. As a consequence, the present invention is again substantially different from the closest known related art.

The preceding two paragraphs taken together should make it clear that what has been described above penults new kinds of multiply-connected hierarchies of linked information between individual video segments which can be edited together in multiple ways, tagged, commented upon, browsed in multiple ways which are all linked back to each unit of time within the original videos while never changing the original videos. All this is effected by users with no special skills.

The ability to track usage as a function of time at a very detailed and complex level involving multiple parameters leads to novel results unavailable from any previously known method: by observing user behaviors in multiple forms as described in ‘a’-‘g’ above, the system creates and can display through the user interface a time-dependent interest intensity profile of a more lengthy video (more generally of any DEVSA) and thus guide subsequent viewers to the most “interesting” portions of the more lengthy video while allowing them to skip the “less interesting” parts and to also, via the user interface, see any tags, comments, etc. which have been added by prior users (or others) as well as to add their own.

Multiple alternative implementations of time-dependent interest intensity are possible. Those of skill in the art of video and other time-based media should be aware that scenes, events, activities etc. within a video have no set time delineation. They may extend for a few seconds or for many minutes or for any time length in between. Without careful viewing of each specific video it is impossible to know when events of potential interest to viewers begin and end. Thus any system intending to identify “interesting sequences” must either be informed by expert human observers or must analyze and track viewers' responses to actually viewing the video.

A valuable, but less preferred, embodiment of interest intensity analysis and display, would divide the overall video into a set of predetermined time sub-segments, for example 30 second intervals throughout the video. It would then accumulate, track and display the usage data as discussed above within each of those predetermined 30 second intervals. Assuming that the interest intensity algorithm has no prior knowledge of the content of the video, the trade-offs between longer intervals (60 seconds vs. 30 seconds for example) vs. shorter intervals (15 seconds vs. 30 seconds for example) include:

Longer Intervals
Advantages: less data to collect, store, analyze and display with consequent decreased cost and increased performance.
Disadvantages: reduced probability that the selected intervals would accurately match the actual segments the users found interesting.

Shorter Intervals
Advantages: increased probability that the selected intervals would accurately match the actual segments the users found interesting.
Disadvantages: more data to collect, store, analyze and display with consequent increased cost and decreased performance.

A preferred embodiment of time-dependent interest intensity treats interest intensity as a continuous function of time within the time domain of the video or other time-based media. As stated previously, using techniques of numerical analysis well known to those of skill in the art of applied mathematics, the programming module can collect all usage data without regard for any predetermined time intervals and use this data to continually formulate a continuous function of time, within the well-known constraints of numerical analysis, representing the interest intensity. Several special benefits arise from this preferred implementation:

User activity of itself defines actual time boundaries of interesting segments of the video.

Data collected, stored, saved and displayed responds only to user activity. Well-known and well-perfected techniques for such processes are available having been applied to other unrelated fields that can be adapted to the issues herein described.

Additionally, auto-play-lists of video or audio could be generated based on the totality of this social browse information to “skip the boring bits for me.” The point being that all users' data is cross-referenced with each individual user's data to determine what is a “boring bit”.

The novel inventive concept discussed herein is best explained by examples.
a. FIG. 12 is an image view of a user-viewed video segment with tagging and details attached. It shows one sample presentation of an interest intensity map and indicates where tags and comments have been placed.
b. FIG. 13 shows, on the right side, accumulating commentary from other users on the video shown in FIG. 12.
c. FIG. 14 shows, at the lower left of the large central thumbnail, a specific comment—obtained by clicking on the relevant icon.
d. FIG. 15 is an image view of a web page showing a tag entry box for synchronous commenting, that is, a comment tied to a specific time internal to the video, on a linked video image.
e. FIG. 16 is an alternative image view of a social browsing system noting multiple tagged scene labels with thumbnail images relating to multiple different times within the video, and a somewhat different display of an interest intensity map or heat map of most to least viewed/tagged/commented portions of the video.
f. FIG. 17 is another alternative video image view of a social browsing system noting particular social, synchronized comments for a particular sub-segment of the video along with an interest intensity map of the video.
The first example, FIGS. 12-15, is a video of a couple's trip to Venice. The originator has uploaded video and inserted comments and tags. FIGS. 12-15 show a progression from what the originator did in FIG. 12 to what others commented upon through the time of the video and the accumulated interest intensity map in FIG. 13 plus icons showing where tags and synchronized comments are within the video. FIG. 14 shows how a user can click on a comment icon and highlight it without having to play the video. FIG. 15 shows a screen a user would utilize to enter a new tag. The interest intensity map shown in FIGS. 12-15 indicates which portions of the video were watched by more or fewer previous users. It also shows where tags have been entered by dots on the map linked to page icons.
The second example is from a TV news broadcast of a police car chase and is shown in the accompanying FIGS. 16-17. The darkness of the bar below the image (an interest intensity map) indicates how many previous viewers actually watched that section, intensified by those who repeated it and de-intensified by those who fast-forwarded through it and by other interest metrics. The user can use his cursor to pick out only as many of those most interesting segments as he wishes and simultaneously see tags and/or comments from previous users. Thus, the user can skip the boring parts and make the experience much more “interesting” to him
b. Those of skill in the art will readily understand another example (not shown) which is the nightly broadcast of the Olympic Winter Games which is 3-4 hours of segments which may be commentary, ads, downhill skiing, figure skating, luge, cross-country skiing, etc. Consider that each segment is tagged according to its contents. Then a user could set his profile to say he wants to watch luge and figure skating but not any downhill or cross-country skiing. The user then sees what he wants. The same “interest intensity” profile, tags, comments etc. can be added except only to the subjects he chooses. This is a new way to watch video and stored television.
c. In another example like (b) above but with reference to the interest metrics from only a single community—e.g. tell me what parts of the Olympics my friends and people who are friends of my friends liked.
d. A natural extension of this idea would be for a basketball game highlights show where users and/or editors comment during the game or shows repeats of plays and thus highlight interesting plays thus creating a highlight reel using the interest intensity profile. A significant advantage is that an individual user can choose (for example) to watch only the “extremely” interesting plays (those with high visual intensity) for a total of 5 minutes or the “very interesting” plays for a total of 15 minutes as the user chooses. Given the above discussions, those of skill in the art should be readily able to determine means to respond to the user request: “Show me the most interesting “N” minutes of this DEVSA”. That is, play the “N” minutes with the highest interest intensity.

While the Applicant recognizes that the linking of end-user devices to Internet-based services has been long and widely discussed as a means to enhance the viewing of video, Applicant finds those discussions generally speculative and non-specific because no clear mechanisms are proffered for detailed implementation especially on the time axis within the DEVSA. The introduction in this and related applications of the novel techniques of metadata/PDLs, deep tags, synchronized comments, visual browsing, social browsing including interest intensity as defined herein all tied to the time domain within the individual DEVSA and all without modifying the individual DEVSA, no matter how combined with other DEVSA, do provide the detailed mechanisms making realistic and implementable such interactions between end-user devices and Internet-based services.

The present invention can be applied in multiple implementation structures to perform functions such as those described in the above paragraphs, and may be:
A. Implemented as a web site employing a user interface, programming module and data module such as described above and in related patent applications (incorporated herein fully by reference).
B. Implemented with functionality primarily on end user devices with digital video recording capabilities (examples are digital video recorders or personal computers) wherein DEVSA arriving at the end user device could be tagged before it arrives with labels, commentary, time-dependent interest intensity, etc. regarding its content and the user could use the invention to control playback of the DEVSA in the manner described previously. The user also could add tags and have those tags sent via data networks to other users in a manner similar to that done on the Internet.
C. A mixed implementation wherein DEVSA is delivered to end user devices via distinct networks or the same networks as tagging information (E.g., DEVSA is delivered via cable TV, satellite or direct broadcast while tagging information is delivered and sent via the Internet. Due to the special capabilities of this invention, especially the logical separation of the metadata from the DEVSA, a unique identification of the DEVSA plus a well-defined time indicator within the DEVSA is adequate to allow the performance of the functions described herein.) This implementation “C” has the advantage of more easy integration of traditional broadband video distribution technologies such as cable TV, satellite TV and direct broadcast with the information sharing capabilities of the Internet as enabled by the current invention.
D. A mixed implementation as in “C” above with the addition that the end user devices such as digital video recorders make available individual usage data such as view, fast forward, etc. as a function of time within each DEVSA and such usage data is made available to the programming module and data module for processing, analysis, and storage and display via the user interface thus adding information to the time-dependent interest intensity analysis as previously described. That usage data could pass via one or more data networks, direct from said end-user device or via another of the user's devices such as a PC linked to the Internet and hence to the server wherein operates the programming module, etc. To the degree permitted by the DVR or similar device the programming module could provide signals to control both playback and user interface displays generated by the DVR. The fundamental point is to make use of both the DEVSA storage and data gathering capabilities of many individual end user devices such as DVRs and, if available, their externally controlled playback and user interface capabilities, while making full use of the multiple user, statistical, centralized analysis and data management capabilities of the programming module and data module as described above.

The present invention enables substantive uses, and these include:

(A) Application in multiple implementation structures to perform functions such as those described in the above paragraphs: Implemented as a web site employing a user interface, programming module and data model such as described above and in related patent applications.

(B) Application implemented with functionality primarily on end-user devices with digital video recording capabilities (examples are digital video recorders or personal computers) wherein DEVSA arriving at the end-user device could be linked to PDLs before it arrives with time-progress indicators, deep tags, synchronized comments, etc. regarding its content and the user could use the invention to control playback of the DEVSA in the manner described previously. The user also could add time-progress indicators deep tags and synchronized comments or Fixed Comments and have those additions to the metadata sent via data networks to other users in a manner similar to that done on the Internet.

As illustrative examples, implementation (B) would provide system for a cable TV company to download a pay-per-view movie to a DVR, and:
1. To employ PDLs and user specific permissions to allow different displays of the movie for different users such as an X-rated version for adults and a G-rated version for others.
2. To employ synchronized comments incorporating a variety of closed caption language translations as the user requests: Ukrainian, Japanese, English, etc.
3. To employ deep tags to provide expert commentary on parts of the movie.
4. To provide time sequence indicators to assist viewers in visual browsing of the movie.
5. To employ a multitude of forms of metadata as discussed herein to permit users to choose alternative playing modes of the movie such as is possible with certain DVDs including alternative endings, differing sound tracks, etc.

Implementation (B) would further penult users to generate such PDLs, synchronized comments and deep tags to accomplish the above. For instance, parents could employ PDLs and user-specific permissions to edit movies themselves prior to allowing their children to watch them.

(C) A mixed implementation wherein DEVSA is delivered to end-user devices via distinct networks or the same networks as time-progress indicators, deep tagging and synchronized comment and Fixed Comment information. (E.g., DEVSA is delivered via cable TV, satellite or direct broadcast while time-progress indicators, deep tagging and synchronized comment and Fixed Comment information is delivered and sent via the Internet. Due to the special capabilities of this invention, especially the logical separation of the metadata from the DEVSA, a unique identification of the DEVSA plus a well-defined time indicator within the DEVSA is adequate to allow the performance of the functions described herein.) This implementation “C” has the advantage of more easy integration of traditional broadband video distribution technologies such as cable TV, satellite TV, and direct broadcast with the information sharing capabilities of the Internet as enabled by the current invention.

As illustrative examples, implementation (C) would provide mechanisms for general Internet users to provide PDLs, synchronized comments and deep tags to accomplish the same ends as those described for implementation (B), including examples wherein:
1. A Finnish Film Society (for example) could provide via a web site linked to the DVR, English translations for Finnish films which would be displayed as synchronized comments as in example number (B) 2 above. These translations could be text or audio delivered via the Internet to the DVR or alternatively to another user device.
2. A professional film expert could offer commentary on films as the film progresses in the form of deep tags provided via a web site linked to the DVR or alternatively to another user device.
3. A chat group's comments on the film could be displayed synchronized with the progress of the film via a web site linked to the DVR or alternatively to another user device.

In all examples (herein and elsewhere), since the DVR is linked to the Internet, if the user pauses, fast forwards, etc., the DVR would provide information to any linked Internet sites about the current time position of the video thus keeping metadata and video synchronized.

(D) A mixed implementation as in “C” above with the addition that the end-user devices such as digital video recorders make available individual usage data such as view, fast forward, etc. as a function of time within each DEVSA and such usage data is made available to the programming module and data model as an additional form of metadata for processing, analysis, and storage and display via the user interface. A simple example of how such information might be used would be: If more than 80% of the last 1000 viewers fast-forwarded through this 45 second interval, it is probably boring and I should skip it. Thus the end-user device contributes data to the time-dependent interest intensity analysis.

As illustrative examples, implementation (D) would provide a system for users watching a football game or any other video being or having been recorded on a DVR to have the same kinds of capabilities illustrated with respect to (B) and (C) above, but in addition gain useful information from the actions of others who have watched the video and, in turn, to provide such information to subsequent watchers, including:
1. While watching a pre-recorded or partially pre-recorded football game many viewers will fast forward through time outs, commercials, lengthy commentaries, half-time, etc. Similarly, many viewers will repeat or slow-play interesting or exciting plays. Via capturing those multiple user actions through the Internet, analyzing that data and then distributing that analyzed data to subsequent viewers, at the user's choice, the fast forwarding could be done automatically using PDLs.
2. While watching the same football game viewers could press “thumbs-up” or “thumbs-down” type buttons, which are a form of deep tag, to signify interesting and non-interesting sequences. Via capturing those multiple user actions through the Internet, analyzing that data and then distributing that analyzed data to subsequent viewers, at the user's choice, only sequences with a high percentage of thumbs-up would be shown thus enabling the user to watch “highlights” as selected by his predecessor viewers.
3. While watching the same football game viewers could enter text or iconic synchronized comments which would then be shared in a similar manner.
4. While watching the same football game viewers could enter Instant Messaging messages directed to specific friends which would appear as synchronized comments to those specific friends who watched the game later.

In all examples, since the DVR is linked to the Internet, if the user pauses, fast forwards, etc., the DVR would provide information to any linked Internet sites about the current time position of the video thus keeping metadata and video synchronized.

Usage data could pass via one or more data networks, direct from said end-user device or via another of the user's devices such as a PC linked to the Internet and hence to the server wherein operates the programming module, etc. To the degree permitted by the DVR or similar device the programming module could provide signals to control both playback and user interface displays generated by the DVR. The fundamental point is to make use of both the DEVSA storage and data gathering capabilities of many individual end-user devices such as DVRs and, if available, their externally controlled playback and user interface capabilities, while making full use of the multiple user, statistical, centralized analysis and data management capabilities of the programming module and data model as described above.

A specific advantage to implementation D, and to a lesser extent implementation C, is that a DVR user who might be the 10,000th viewer of a broadcast program has the advantage of all the experiences of the previous 9,999 viewers with regard to what parts of the show are interesting, exciting, boring, or whatever plus their time-progress indicators, deep tags and synchronized comments on what was going on.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An electronic system, for enabling an enhanced social browsing of networked time-based media by a plurality of users including at least a first user through at least one of a plurality of user interfaces, said electronic system comprising:
at least one user computerized electronic memory device enabling a manipulation of said time-based media including at least a first time-based media;
user interface means for receiving, for encoding, and for storing said at least first time-based media in at least a first initial encoded state in an electronic system environment in a manner available to said plurality of users;
metadata system means for creating, storing, and managing at least a first layer of time-dependent metadata in a manner associated with at least said first initial encoded state of said encoded time-based media without modifying said at least first initial encoded state of said encoded time-based media, and in a manner associated with each respective said users interaction;
time sequence means in said metadata system means for generating a sequence of time informational indicators enabling each said user to perceive a useful progression through time of said at least first encoded time-based media;
electronic interaction system means for enabling said plurality of users to interact respectively with said time sequence means and said metadata system means for creating, storing, and managing said at least first layer of metadata according to a plurality of stored respective playback decision lists of ones respective of said plurality of users;
said electronic interaction system means including means for enabling a plurality of display control modes and a plurality of play modes of said encoded time-based media according to said respective playback decision lists of ones of said plurality of users; and
said electronic interaction system means further comprising:
social management module means for storing and analyzing each said respective interaction with said encoded time-based media by each respective user through said electronic interaction system means, whereby said social management module means enables said enhanced social browsing of said networked time-based media.

2. An electronic system, according to claim 1, wherein:
said electronic interaction system means for enabling a plurality of users to interact, further comprises:
means for enabling a plurality of user interactions, said user interactions including at least one user interaction selected from a group comprising:
editing, virtual browsing, segment viewing, tagging, deep tagging, commenting, synchronized commenting, social browsing, granting of permissions, restricting of permissions, and creation of a permanent media form linked to respective said user modifications.

3. An electronic system, according to claim 1, wherein:
said social management module means for storing and analyzing each said respective interaction with said encoded time-based media, further comprises:
at least one means for analyzing user interactions with said encoded time-based media, said means for analyzing user interactions including at least one means for analyzing selected from a group comprising:
a personal interest profile analysis, a tag tracking search analysis, a pattern matching analysis, and a time-dependent interest intensity mapping analysis, whereby said electronic interaction system means enables a multivariate analysis of interaction data to enhance said social browsing.

4. An electronic system, according to claim 2, wherein:
said user deep tagging interaction includes the generation of at least one tag type selected from a group comprising:
user identification, user hierarchy, user-defined use modalities, user descriptive comments reviewable by other users, user instructions to jump to a particular selected sequence in a visual browsing enabled mode, user-personalized sequence indicator identifiers, electronic instructions to change a visual display instruction of a selected sequence, and a system-searchable deep tag available to other users.

5. An electronic system, according to claim 3, wherein:
said at least one means for analyzing user interactions includes said personal interest profile analysis; and
said personal interest profile analysis includes a multivariate analysis of a compilation of interaction information compiled from each stored respective users profile and at least one other interactive information type selected from each respective user's viewing history, display control history, commenting history, and editing history, whereby said multivariate analysis enhances said social browsing of networked time-based media by a plurality of users.

6. An electronic system, according to claim 3, wherein:
said at least one means for analyzing user interactions includes said tag tracking search analysis; and
said tag tracking search analysis includes a multivariate analysis of interaction information compiled from respective users' efforts employing system methods and system tools to search for encoded time-based media segments with tags indicating respective individual user interest and any associated user groups interest, whereby said multivariate analysis enhances said social browsing of networked time-based media by a plurality of users.

7. An electronic system, according to claim 3, wherein:
said at least one means for analyzing user interactions includes said pattern matching analysis; and
said pattern matching analysis includes a multivariate analysis of combined interaction information compiled from other patterns of interests from each respective user and a respective said user's interest profile, whereby said multivariate analysis enhances said social browsing of networked time-based media by a plurality of users.

8. An electronic system, according to claim 3, wherein:
said at least one means for analyzing user interactions includes said time-dependent interest intensity mapping analysis; and
said time-dependent interest intensity mapping analysis includes a continuous metric measurement linked with a time interval display of an encoded time-based media demonstrating visually earlier said users' multiple active and passive behaviors involving said encoded time-based media; whereby said multivariate analysis enhances said social browsing of networked time-based media by a plurality of users.

9. An electronic system, according to claim 8, wherein:
said users multiple active and passive behaviors include at least one behavior selected from a group of behaviors comprising; user viewing behavior, user browsing behavior, user tagging behavior, user commenting behavior, user visual browsing behavior, and user social browsing behavior.

10. An electronic system, according to claim 9, wherein:
said time-dependent interest intensity analysis is maintained in memory as a continuous function of time through each respective encoded time-based media, whereby said social management module means calculates and displays a time-dependent interest intensity calculated from at least one of: data from all said plurality of viewers, data for a specified subset of viewers, and data from a single viewer.

11. An electronic system, according to claim 1, wherein:
said metadata system means for creating, storing, and managing, and said electronic interaction system means for enabling said plurality of users to interact respectively with said time sequence means and said metadata system means tracks and stores each said users episodic interaction with said electronic system; and
said users episodic interactions include at least one interaction selected from a group of interactions containing:
user interactions for viewing of specific segments, user interactions for specifying which user steps are activated in reviewing said encoded time-based media, user interactions including a number of sharing users and a subsequent sharing action by sharees, a number of said users entering and viewing said deep tags, and a synchronous commenting, a generation of a hierarchical interest category, and a generation of a prioritized list and time-variable display of said prioritized list.

12. An operational system, for providing enhanced social browsing of networked time-based media for at least one of a plurality of users of time-based media, comprising:
means for receiving via a user interface system a user-transferred time-based media in an electronic operational environment including an electronic memory device and a user interface system;
means for encoding said uploaded time-based media and for storing said encoded time-based media in an initial state;
metadata creation means for establishing metadata associated with said encoded time-based media;
means for providing a system of sequenced time informational indicators enabling said user to at least visually perceive a progression through time of said encoded time-based media;
an electronic interaction system enabling said at least one user to interact with and modify said established metadata associated with said encoded time-based media in at least a first stored playback decision list via a communication path including said user interface system, whereby each respective and separately stored said stored playback decision list of said at least one user of said plurality of users modifies said respective established metadata without modifying said encoded time-based media in said initial state;
said electronic interaction system including a display control means and a play control means enabling each one of said plurality of users to display and play said encoded time-based media in a modified manner according to each respective said one user's respective playback decision list without modifying said encoded time-based media; and
social management module means for storing and analyzing each said respective interaction with said time-based media by each respective user through said electronic interaction system, whereby said social management module means enables said enhanced social browsing of said networked time-based media based on said storing and analyzing.

13. An operational system, according to claim 12, wherein:
said social management module means for storing and analyzing each said respective interactions with said encoded time-based media, further comprises:
at least one means for analyzing user interactions, said means for analyzing user interactions including at least one means for analyzing selected from a group comprising:
a personal interest profile analysis, a tag tracking search analysis, a pattern matching analysis, and a time-dependent interest intensity mapping analysis, whereby said social management module means for storing and analyzing enables a multivariate analysis of interaction data to enhance said social browsing.

14. An operational system, according to claim 13, wherein:
said at least one means for analyzing user interactions includes said personal interest profile analysis; and
said personal interest profile analysis includes a multivariate analysis of a compilation of interaction information compiled from each stored respective users profile and at least one other interactive information type selected from each respective user's viewing history, display control history, commenting history, sharing history, and editing history, whereby said multivariate analysis enhances said social browsing of networked time-based media by said plurality of users.

15. An operational system, according to claim 13, wherein:
said at least one means for analyzing user interactions includes said tag tracking search analysis; and
said tag tracking search analysis includes a multivariate analysis of interaction information compiled from respective users' efforts employing system methods and system tools to search for encoded time-based media segments with tags indicating respective individual user interest and any associated user groups interest, whereby said multivariate analysis enhances said social browsing of networked time-based media by said plurality of users.

16. An operational system, according to claim 13, wherein:
said at least one means for analyzing user interactions includes said pattern matching analysis; and
said pattern matching analysis includes a multivariate analysis of combined interaction information compiled from other patterns of interests from each respective user and a respective said user's interest profile, whereby said multivariate analysis enhances said social browsing of networked time-based media by said plurality of users.

17. An operational system, according to claim 13, wherein:
said at least one means for analyzing user interactions includes said time-dependent interest intensity mapping analysis; and
said time-dependent interest intensity mapping analysis includes a continuous metric measurement linked with a time interval display of an encoded time-based media demonstrating visually earlier said users multiple active and passive behaviors involving said encoded time-based media; whereby said multivariate analysis enhances said social browsing of networked time-based media by said plurality of users.

18. An operational system, according to claim 17, wherein:
said users multiple active and passive behaviors include at least one behavior selected from a group of behaviors comprising: user viewing behavior, user browsing behavior, user tagging behavior, user commenting behavior, user visual browsing behavior, user sharing behavior, and user social browsing behavior.

19. An operational system, according to claim 17, wherein:
said time-dependent interest intensity analysis is maintained in memory as a continuous function of time through each respective encoded time-based media, whereby said social management module means calculates and displays a time-dependent interest intensity calculated from at least one of: data from all said plurality of viewers, data for a specified subset of viewers, and data from a single viewer.

20. An operational system, according to claim 12, wherein:
said electronic interaction system, further comprises:
means for enabling a plurality of user interactions, said user interactions including at least one user interaction selected from a group comprising:
editing, virtual browsing, segment viewing, tagging, deep tagging, commenting, synchronized commenting, social browsing, sharing, granting of permissions, restricting of permissions, and creation of a permanent media form linked to respective said user modifications.

21. An operational system, according to claim 20, wherein:
said user deep tagging interaction includes the generation of at least one tag type selected from a group comprising:
user identification, user hierarchy, user-defined use modalities, user descriptive comments reviewable by other users, user instructions to jump to a particular selected sequence in a visual browsing enabled mode, user-personalized sequence indicator identifiers, electronic instructions to change a visual display instruction of a selected sequence, and a system-searchable deep tag available to other users.

22. A method for providing enhanced social browsing of networked time-based media for a plurality of users including at least a first user, via a plurality of user interfaces, the method comprising the steps of:
providing a computer system receiving at least a first of a plurality of user transfers of said time-based media in an operational environment through a user interface system;
providing means for encoding said at least first of said user transfers of said time-based media in an initial state separate from subsequent user transfers;
providing computer memory means for storing said encoded first time-based media in said initial state separate from said subsequent user transfers;
providing a metadata creation means for initially establishing metadata associated with respective user transfers of time-based media;
said computer memory means storing said established metadata associated with said encoded time-based media separately from said encoded time-based media in said initial state;
providing means for individually modifying said established metadata as an individual playback decision list and for individually storing said playback decision list separately from said respective initial state encoded time-based media and said respective initial metadata, thereby enabling an individual modification of respective said playback decision lists without a modification of said initial state encoded time-based media and said respective initial metadata;
providing means for enabling at least one of a visual browsing, a tagging, a deep tagging, and a synchronized commenting regarding encoded time-based media content, said means for enabling at least one, further comprising:
at least a first underlying programming module for enabling interacting with said at least a first user by said plurality of users; and
an interactive data model constructing, storing, and tracking each user modification and review of each user action relative to said at least one of a visual browsing, a tagging, deep tagging, and a synchronized commenting within respective user playback decision lists; and
social management module means for storing and analyzing each said respective interaction with said encoded time-based media by each respective user through an electronic interaction system means, whereby said social management module means enables said enhanced social browsing of said networked time-based media.

23. A method, according to claim 22, wherein:
said social management module means for storing and analyzing each said respective interaction with said encoded time-based media, further comprises:
at least one means for analyzing user interactions, said means for analyzing user interactions including at least one means for analyzing selected from a group comprising:
a personal interest profile analysis, a tag tracking search analysis, a pattern matching analysis, and a time-dependent interest intensity mapping analysis, whereby said social management module means enables a multivariate analysis of interaction data to enhance said social browsing.
